(19) United States
(12) Patent Application Publication
(10) Pub. No.: US 2025/0031118 A1
(43) Pub. Date: Jan. 23, 2025

(54) METHOD AND APPARATUS FOR HANDLING UE-INITIATED BEAM CHANGE IN A WIRELESS COMMUNICATION SYSTEM

(71) Applicant: ASUS Technology Licensing Inc., Taipei City (TW)

(72) Inventors: Yi-Hsuan Kung, Taipei City (TW); Yu-Hsuan Guo, Taipei City (TW)

(21) Appl. No.: 18/772,002

(22) Filed: Jul. 12, 2024

Related U.S. Application Data
(60) Provisional application No. 63/527,300, filed on Jul. 17, 2023.

(51) Int. Cl. H04W 36/08; H04W 36/00; H04W 36/36

(52) U.S. Cl. CPC H04W 36/085; H04W 36/0079; H04W 36/36

(57) ABSTRACT

Methods, systems, and apparatuses are provided for handling User Equipment (UE)-initiated beam change in a wireless communication system, with a method of a UE comprising triggering or initiating a UE-initiated beam switching associated with a Cell, transmitting a beam switching indication associated with the Cell in response to the UE-initiated beam switching, and performing, in response to considering the UE-initiated beam switching to be not successful, or expiration of a timer, at least one of: canceling the triggered UE-initiated beam switching associated with the Cell, and/or canceling a Scheduling Request (SR) associated with the UE-initiated beam switching, and/or stopping a Random Access (RA) procedure associated with the UE-initiated beam switching, and/or triggering a Beam Failure Recovery (BFR) associated with the Cell, and/or retransmitting the beam switching indication, and/or generating and transmitting a second beam switching indication.

### CROSS-REFERENCE TO RELATED APPLICATIONS

The present application claims priority to and the benefit of U.S. Provisional Patent Application Ser. No. 63/527,300, filed Jul. 17, 2023, which is fully incorporated herein by reference.

### FIELD

This disclosure generally relates to wireless communication networks and, more particularly, to a method and apparatus for handling UE-initiated beam change in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for measurement, switching, and error handling for User Equipment (UE)-initiated beam switching.

In various embodiments, a method of a UE comprises triggering or initiating a UE-initiated beam switching associated with a Cell, transmitting a beam switching indication associated with the Cell in response to the UE-initiated beam switching, and performing, in response to considering the UE-initiated beam switching to be not successful, or expiration of a timer, at least one of: canceling the triggered UE-initiated beam switching associated with the Cell, and/or canceling a Scheduling Request (SR) associated with the UE-initiated beam switching, and/or stopping a Random Access (RA) procedure associated with the UE-initiated beam switching, and/or triggering a Beam Failure Recovery (BFR) associated with the Cell, and/or retransmitting the beam switching indication, and/or generating and transmitting a second beam switching indication.

In various embodiments, a method of a UE comprises triggering or initiating a UE-initiated beam switching associated with a Cell, receiving a beam change indication from a network before transmitting a beam switching indication associated with the Cell in response to the UE-initiated beam switching, and canceling the triggered UE-initiated beam switching associated with the Cell in response to reception of the beam change indication.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 6.1.3.14-1: TCI States Activation/Deactivation for UE-specific PDSCH MAC CE, from 3GPP 38,321 v17.4.0.

FIG. 6 is a reproduction of FIG. 6.1.3.15-1: TCI State Indication for UE-specific PDCCH MAC CE, from 3GPP 38,321 v17.4.0.

FIG. 7 is a reproduction of FIG. 6.1.3.18-1: PUCCH spatial relation Activation/Deactivation MAC CE, from 3GPP 38,321 v17.4.0.

FIG. 8 is a reproduction of FIG. 6.1.3.24-1: Enhanced TCI States Activation/Deactivation for UE-specific PDSCH MAC CE, from 3GPP 38,321 v17.4.0.

FIG. 9 is a reproduction of FIG. 6.1.3.25-1: Enhanced PUCCH spatial relation Activation/Deactivation MAC CE, from 3GPP 38,321 v17.4.0.

FIG. 10 is a reproduction of FIG. 6.1.3.44-1: Enhanced TCI States Indication for UE-specific PDCCH MAC CE, from 3GPP 38,321 v17.4.0.

FIG. 11 is a reproduction of FIG. 6.1.3.47-1: Unified TCI state activation/deactivation MAC CE, from 3GPP 38,321 v17.4.0.

FIG. 12 is a reproduction of Figure x, Signaling procedure for LTM, from R2-2213332 38.300 running CR for introduction of NR further mobility enhancements.

FIG. 13 is an example diagram showing that a UE could be configured and/or activated with a current beam for a DL or UL channel, in accordance with embodiments of the present invention.

FIG. 14 is an example diagram showing that a UE could start a timer in response to transmitting the beam switching indication, in accordance with embodiments of the present invention.

FIG. 15 is an example diagram showing that a UE could consider the beam switching procedure to be not successful in response to receiving a negative acknowledgement associated with the beam switching indication, in accordance with embodiments of the present invention.

FIG. 16 is an example diagram showing that a UE (with a pending, triggered, and not canceled beam switching) could receive a beam change indication from the network, in accordance with embodiments of the present invention.

FIG. 17 is an example diagram showing a UE configured with a maximum transmission number for the beam switching indication, in accordance with embodiments of the present invention.

FIG. 18 is an example diagram showing that a UE could trigger a (UE-initated) beam switching associated with a Cell in response to an event (e.g., current beam quality is lower than a threshold), in accordance with embodiments of the present invention.

FIG. 19 is a flow diagram of a method of a UE comprising generating a beam switching indication associated with a Cell, starting a first timer in response to transmitting the beam switching indication to a network, and considering the beam switching indication to be not transmitted successfully in response to expiration of the first timer, in accordance with embodiments of the present invention.

FIG. 20 is a flow diagram of a method of a UE comprising generating a beam switching indication associated with a Cell, transmitting the beam switching indication to a network, receiving a beam change indication associated with the Cell from the network, and applying a second beam in the beam change indication on the Cell, in accordance with embodiments of the present invention.

FIG. 21 is a flow diagram of a method of a UE comprising triggering or initiating a UE-initiated beam switching associated with a Cell, transmitting a beam switching indication associated with the Cell in response to the UE-initiated beam switching, and performing, in response to considering the UE-initiated beam switching to be not successful, or expiration of a timer, at least one of: canceling the triggered UE-initiated beam switching associated with the Cell, and/or canceling an SR associated with the UE-initiated beam switching, and/or stopping an RA procedure associated with the UE-initiated beam switching, and/or triggering a BFR associated with the Cell, and/or retransmitting the beam switching indication, and/or generating and transmitting a second beam switching indication, in accordance with embodiments of the present invention.

FIG. 22 is a flow diagram of a method of a UE comprising triggering or initiating a UE-initiated beam switching associated with a Cell, receiving a beam change indication from a network before transmitting a beam switching indication associated with the Cell in response to the UE-initiated beam switching, and canceling the triggered UE-initiated beam switching associated with the Cell in response to reception of the beam change indication, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] 3GPP 38,214 v17.4.0; [2] 3GPP 38,321 v17.4.0; [3] 3GPP 38,331 v17.4.0; and [4] R2-2213332 38.300 running CR for introduction of NR further mobility enhancements. The standards and documents listed above are hereby expressly and fully incorporated herein by reference in their entirety.

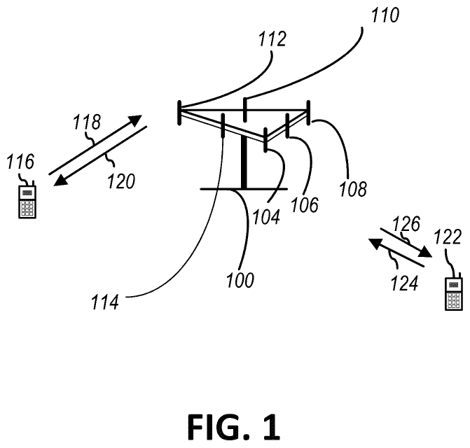

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

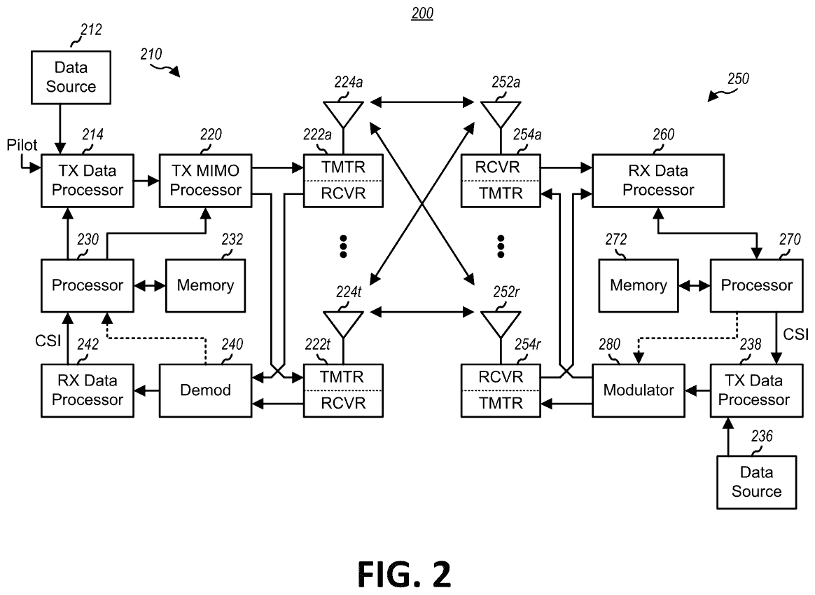

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

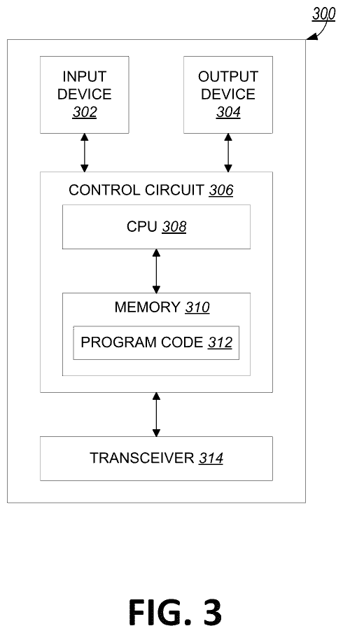

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

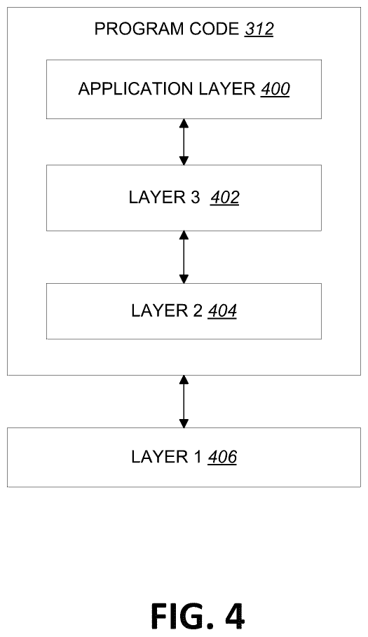

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In 38.214 ([1] 3GPP 38,214 v17.4.0), beam reporting and channel state information reporting is introduced:

### 5.2 UE Procedure for Reporting Channel State Information (CSI)

### 5.2.1 Channel State Information Framework

The procedures on aperiodic CSI reporting described in this clause assume that the CSI reporting is triggered by DCI format 0_1, but they equally apply to CSI reporting triggered by DCI format 0_2, by applying the higher layer parameter reportTriggerSizeDCI-0-2 instead of reportTriggerSize.

The time and frequency resources that can be used by the UE to report CSI are controlled by the gNB. CSI may consist of Channel Quality Indicator (CQI), precoding matrix indicator (PMI), CSI-RS resource indicator (CRI), SS/PBCH Block Resource indicator (SSBRI), layer indicator (LI), rank indicator (RI), L1-RSRP, L1-SINR or CapabilityIndex.

For CQI, PMI, CRI, SSBRI, LI, RI, L1-RSRP, L1-SINR, Capability [Set] Index a UE is configured by higher layers with N≥1 CSI-ReportConfig Reporting Settings, M≥1 CSI-ResourceConfig Resource Settings, and one or two list(s) of trigger states (given by the higher layer parameters CSI-AperiodicTriggerState List and CSI-SemiPersistentOnPUSCH-TriggerStateList). Each trigger state in CSI-AperiodicTriggerStateList contains a list of associated CSI-ReportConfigs indicating the Resource Set IDs for channel and optionally for interference. Each trigger state in CSI-SemiPersistentOnPUSCH-TriggerState List contains one associated CSI-ReportConfig.

### 5.2.1.1 Reporting Settings

Each Reporting Setting CSI-ReportConfig is associated with a single downlink BWP (indicated by higher layer parameter BWP-Id) given in the associated CSI-ResourceConfig for channel measurement and contains the parameter(s) for one CSI reporting band: codebook configuration including codebook subset restriction, time-domain behavior, frequency granularity for CQI and PMI, measurement restriction configurations, and the CSI-related quantities to be reported by the UE such as the layer indicator (LI), L1-RSRP, L1-SINR, CRI, and SSBRI (SSB Resource Indicator) and CapabilityIndex.

The time domain behavior of the CSI-ReportConfig is indicated by the higher layer parameter reportConfigType and can be set to ‘aperiodic’, ‘semiPersistentOnPUCCH’, ‘semiPersistentOnPUSCH’, or ‘periodic’. For ‘periodic’ and ‘semiPersistentOnPUCCH’/‘semiPersistentOnPUSCH’ CSI reporting, the configured periodicity and slot offset applies in the numerology of the UL BWP in which the CSI report is configured to be transmitted on. The higher layer parameter reportQuantity indicates the CSI-related, L1-RSRP-related, L1-SINR-related or CapabilityIndex-related quantities to report. The reportFreqConfiguration indicates the reporting granularity in the frequency domain, including the CSI reporting band and if PMI/CQI reporting is wideband or sub-band. The timeRestrictionForChannelMeasurements parameter in CSI-ReportConfig can be configured to enable time domain restriction for channel measurements and time Restriction ForInterferenceMeasurements can be configured to enable time domain restriction for interference measurements. The CSI-ReportConfig can also contain CodebookConfig, which contains configuration parameters for Type-I, Type II, Enhanced Type II CSI, or Further Enhanced Type II Port Selection including codebook subset restriction when applicable, and configurations of group-based reporting. A UE is not expected to be configured with a CSI report setting associated with a dormant DL BWP if the reportConfigType is set to ‘aperiodic’.

### 5.2.1.4 Reporting Configurations

The UE shall calculate CSI parameters (if reported) assuming the following dependencies between CSI parameters (if reported)
LI shall be calculated conditioned on the reported CQI, PMI, RI and CRI
CQI shall be calculated conditioned on the reported PMI, RI and CRI
PMI shall be calculated conditioned on the reported RI and CRI
RI shall be calculated conditioned on the reported CRI.

The Reporting configuration for CSI can be aperiodic (using PUSCH), periodic (using PUCCH) or semi-persistent (using PUCCH, and DCI activated PUSCH). The CSI-RS Resources can be periodic, semi-persistent, or aperiodic. Table 5.2.1.4-1 shows the supported combinations of CSI Reporting configurations and CSI-RS Resource configurations and how the CSI Reporting is triggered for each CSI-RS Resource configuration. Periodic CSI-RS is configured by higher layers. Semi-persistent CSI-RS is activated and deactivated as described in Clause 5.2.1.5.2. Aperiodic CSI-RS is configured and triggered/activated as described in Clause 5.2.1.5.1.

TABLE 5.2.1.4-1
Triggering/Activation of CSI Reporting for the possible CSI-RS Configurations.

| | Periodic CSI | Semi-Persistent CSI | Aperiodic CSI |
|---|---|---|---|
| CSI-RS Configuration | Reporting | Reporting | Reporting |
| Periodic CSI-RS | No dynamic | For reporting on PUCCH, | Triggered by DCI; |
| | triggering/activation | the UE receives an | additionally, subselection |
| | | activation command, as | indication as described in |
| | | described in clause | clause 6.1.3.13 of [10, TS |
| | | 6.1.3.16 of [10, TS 38.321]; | 38.321] possible as defined |
| | | for reporting on PUSCH, | in Clause 5.2.1.5.1. |
| | | the UE receives triggering | |
| | | on DCI | |
| Semi-Persistent CSI-RS | Not Supported | For reporting on PUCCH, | Triggered by DCI; |
| | | the UE receives an | additionally, subselection |
| | | activation command, as | indication as described in |
| | | described in clause | clause 6.1.3.13 of [10, TS |
| | | 6.1.3.16 of [10, TS 38.321]; | 38.321] possible as defined |
| | | for reporting on PUSCH, | in Clause 5.2.1.5.1. |
| | | the UE receives triggering | |
| | | on DCI | |
| Aperiodic CSI-RS | Not Supported | Not Supported | Triggered by DCI; |
| | | | additionally, subselection |
| | | | indication as described in |
| | | | clause 6.1.3.13 of [10, TS |
| | | | 38.321] possible as defined |
| | | | in Clause 5.2.1.5.1. |

### 5.2.1.4.2 Report Quantity Configurations

A UE may be configured with a CSI-ReportConfig with the higher layer parameter reportQuantity set to either ‘none’, ‘cri-RI-PMI-CQI’, ‘cri-RI-i1’, ‘cri-RI-i1-CQI’, ‘cri-RI-CQI’, ‘cri-RSRP’, ‘cri-SINR’, ‘ssb-Index-RSRP’, ‘ssb-Index-SINR’, ‘cri-RI-LI-PMI-CQI’, ‘cri-RSRP-Index’, ‘ssb-Index-RSRP-Index’, ‘cri-SINR-Index’ or ‘ssb-Index-SINR-Index’.

### 5.2.1.4.3 L1-RSRP Reporting

### For L1-RSRP Computation

the UE may be configured with CSI-RS resources, SS/PBCH Block resources or both CSI-RS and SS/PBCH block resources, when resource-wise quasi co-located with ‘type C’ and ‘typeD’ when applicable.
the UE may be configured with CSI-RS resource setting up to 16 CSI-RS resource sets having up to 64 resources within each set. The total number of different CSI-RS resources over all resource sets is no more than 128.

For L1-RSRP reporting, if the higher layer parameter nrofReportedRS in CSI-ReportConfig is configured to be one, the reported L1-RSRP value is defined by a 7-bit value in the range [−140, −44] dBm with 1 dB step size, if the higher layer parameter nrofReportedRS is configured to be larger than one, or if the higher layer parameter groupBasedBeamReporting is configured as ‘enabled’, or if the higher layer parameter groupBasedBeamReporting-r17 is configured, the UE shall use differential L1-RSRP based reporting, where the largest measured value of L1-RSRP is quantized to a 7-bit value in the range [−140, −44] dBm with 1 dB step size, and the differential L1-RSRP is quantized to a 4-bit value. The differential L1-RSRP value is computed with 2 dB step size with a reference to the largest measured L1-RSRP value which is part of the same L1-RSRP reporting instance. The mapping between the reported L1-RSRP value and the measured quantity is described in [11, TS 38.133].

When the higher layer parameter groupBasedBeamReporting-r17in CSI-ReportConfig is configured, the UE shall indicate the CSI Resource Set associated with the largest measured value of L1-RSRP, and for each group, CRI or SSBRI of the indicated CSI Resource Set is present first.

If the higher layer parameter time Restriction ForChannelMeasurements in CSI-ReportConfig is set to “notConfigured”, the UE shall derive the channel measurements for computing L1-RSRP value reported in uplink slot n based on only the SS/PBCH or NZP CSI-RS, no later than the CSI reference resource, (defined in TS 38.211 [4]) associated with the CSI resource setting.

If the higher layer parameter time Restriction ForChannelMeasurements in CSI-ReportConfig is set to “Configured”, the UE shall derive the channel measurements for computing L1-RSRP reported in uplink slot n based on only the most recent, no later than the CSI reference resource, occasion of SS/PBCH or NZP CSI-RS (defined in [4, TS 38.211]) associated with the CSI resource setting.

When the UE is configured with SSB-MTC-AddtionalPCI, a CSI-SSB-ResourceSet configured for L1-RSRP reporting includes one set of SSB indices and one set of PCI indices, where each SSB index is associated with a PCI index.

When the UE is configured with a CSI-ReportConfig with the higher layer parameter reportQuantity set to ‘cri-RSRP-Index’ or ‘ssb-Index-RSRP-Index’ an index of UE capability value set, indicating the maximum supported number of SRS antenna ports, is reported along with the pair of SSBRI/CRI and L1-RSRP.

### 5.2.1.4.4 L1-SINR Reporting

For L1-SINR computation, for channel measurement the UE may be configured with NZP CSI-RS resources and/or SS/PBCH Block resources, for interference measurement the UE may be configured with NZP CSI-RS or CSI-IM resources.
for channel measurement, the UE may be configured with CSI-RS resource setting with up to 16 resource sets, with a total of up to 64 CSI-RS resources or up to 64 SS/PBCH Block resources.

For L1-SINR reporting, if the higher layer parameter nrofReportedRS in CSI-ReportConfig is configured to be one, the reported L1-SINR value is defined by a 7-bit value in the range [−23, 40] dB with 0.5 dB step size, and if the higher layer parameter nrofReportedRS is configured to be larger than one, or if the higher layer parameter groupBasedBeamReporting is configured as ‘enabled’, the UE shall use differential L1-SINR based reporting, where the largest measured value of L1-SINR is quantized to a 7-bit value in the range [−23, 40] dB with 0.5 dB step size, and the differential L1-SINR is quantized to a 4-bit value. The differential L1-SINR is computed with 1 dB step size with a reference to the largest measured L1-SINR value which is part of the same L1-SINR reporting instance. When NZP CSI-RS is configured for channel measurement and/or interference measurement, the reported L1-SINR values should not be compensated by the power offset(s) given by higher layer parameter powerControOffsetSS or powerControlOffset.

In 38.321 ([2] 3GPP 38,321 v17.4.0), Scheduling Request and Medium Access Control (MAC) Control Elements (CEs) for (de) activation of beam(s), reference signal(s), or TCI state(s) are introduced:

### 5.4.4 Scheduling Request

The Scheduling Request (SR) is used for requesting UL-SCH resources for new transmission.

The MAC entity may be configured with zero, one, or more SR configurations. An SR configuration consists of a set of PUCCH resources for SR across different BWPs and cells. For a logical channel or for SCell beam failure recovery (see clause 5.17) and for consistent LBT failure recovery (see clause 5.21), at most one PUCCH resource for SR is configured per BWP. For a logical channel serving a radio bearer configured with SDT, PUCCH resource for SR is not configured for SDT. For beam failure recovery of BFD-RS set(s) of Serving Cell, up to two PUCCH resources for SR is configured per BWP. For positioning measurement gap activation/deactivation request, a dedicated SR configuration is configured.

Each SR configuration corresponds to one or more logical channels and/or to SCell beam failure recovery and/or to consistent LBT failure recovery and/or to beam failure recovery of a BFD-RS set and/or to positioning measurement gap activation/deactivation request. Each logical channel, SCell beam failure recovery, beam failure recovery of a BFD-RS set and consistent LBT failure recovery, may be mapped to zero or one SR configuration, which is configured by RRC. The SR configuration of the logical channel that triggered a BSR (clause 5.4.5) or the SCell beam failure recovery or the beam failure recovery of a BFD-RS set or the consistent LBT failure recovery (clause 5.21) (if such a configuration exists) or positioning measurement gap activation/deactivation request (clause 5.25) is considered as corresponding SR configuration for the triggered SR. Any SR configuration may be used for an SR triggered by Pre-emptive BSR (clause 5.4.7) or Timing Advance reporting (clause 5.4.8).

RRC configures the following parameters for the scheduling request procedure:
sr-ProhibitTimer (per SR configuration);
sr-TransMax (per SR configuration).

The following UE variables are used for the scheduling request procedure:
SR_COUNTER (per SR configuration).

If an SR is triggered and there are no other SRs pending corresponding to the same SR configuration, the MAC entity shall set the SR_COUNTER of the corresponding SR configuration to 0.

When an SR is triggered, it shall be considered as pending until it is cancelled.

All pending SR(s) for BSR triggered according to the BSR procedure (clause 5.4.5) prior to the MAC PDU assembly shall be cancelled and each respective sr-ProhibitTimer shall be stopped when the MAC PDU is transmitted and this PDU includes a Long or Short BSR MAC CE which contains buffer status up to (and including) the last event that triggered a BSR (see clause 5.4.5) prior to the MAC PDU assembly. All pending SR(s) for BSR triggered according to the BSR procedure (clause 5.4.5) shall be cancelled and each respective sr-ProhibitTimer shall be stopped when the UL grant(s) can accommodate all pending data available for transmission.

The MAC entity shall for each pending SR not triggered according to the BSR procedure (clause 5.4.5) for a Serving Cell:
1> if this SR was triggered by Pre-emptive BSR procedure (see clause 5.4.7) prior to the MAC PDU assembly and a MAC PDU containing the relevant Pre-emptive BSR MAC CE is transmitted; or
1> if this SR was triggered by beam failure recovery (see clause 5.17) of an SCell and a MAC PDU is transmitted and this PDU includes a MAC CE for BFR which contains beam failure recovery information for this SCell; or
1> if this SR was triggered by beam failure recovery (see clause 5.17) for a BFD-RS set of a Serving Cell and a MAC PDU is transmitted and this PDU includes an Enhanced BFR MAC CE or a Truncated Enhanced BFR MAC CE which contains beam failure recovery information for this BFD-RS set of the Serving Cell; or
1> if this SR was triggered by beam failure recovery (see clause 5.17) of an SCell and this SCell is deactivated (see clause 5.9); or
1> if this SR was triggered by beam failure recovery (see clause 5.17) for a BFD-RS set of an SCell and this SCell is deactivated (see clause 5.9); or
1> if the SR is triggered by positioning measurement gap activation/deactivation request (see clause 5.25) and the Positioning Measurement Gap Activation/Deactivation Request MAC CE that triggers the SR has already been cancelled; or
1> if this SR was triggered by consistent LBT failure recovery (see clause 5.21) of an SCell and a MAC PDU is transmitted and the MAC PDU includes an LBT failure MAC CE that indicates consistent LBT failure for this SCell; or
1> if this SR was triggered by consistent LBT failure recovery (see clause 5.21) of an SCell and all the triggered consistent LBT failure(s) for this SCell are cancelled; or
1> if this SR was triggered by Timing Advance reporting (see clause 5.4.8) and all the triggered Timing Advance reports are cancelled:
   2> cancel the pending SR and stop the corresponding sr-ProhibitTimer, if running.

Only PUCCH resources on a BWP which is active at the time of SR transmission occasion are considered valid.

As long as at least one SR is pending, the MAC entity shall for each pending SR:
1> if the MAC entity has no valid PUCCH resource configured for the pending SR:
   2> initiate a Random Access procedure (see clause 5.1) on the SpCell and cancel the pending SR.
1> else, for the SR configuration corresponding to the pending SR:
   2> when the MAC entity has an SR transmission occasion on the valid PUCCH resource for SR configured; and
   2> if sr-ProhibitTimer is not running at the time of the SR transmission occasion; and
   2> if the PUCCH resource for the SR transmission occasion does not overlap with a measurement gap:
      4> consider the SR transmission as a prioritized SR transmission.
      4> consider the other overlapping uplink grant(s), if any, as a de-prioritized uplink grant(s), except for the overlapping uplink grant(s) whose simultaneous transmission is allowed by configuration of simultaneousPUCCH-PUSCH or simultaneousPUCCH-PUSCH-SecondaryPUCCHgroup or simultaneousSR-PUSCH-diffPUCCH-Groups;
      4> if the de-prioritized uplink grant(s) is a configured uplink grant configured with autonomousTx whose PUSCH has already started:
         5> stop the configuredGrantTimer for the corresponding HARQ process of the de-prioritized uplink grant(s);
         5> stop the cg-RetransmissionTimer for the corresponding HARQ process of the de-prioritized uplink grant(s).
      4> if SR_COUNTER<sr-TransMax:
         5> instruct the physical layer to signal the SR on one valid PUCCH resource for SR;
         5> if LBT failure indication is not received from lower layers:
         6> increment SR_COUNTER by 1;
         6> start the sr-ProhibitTimer.
         5> else if Ibt-FailureRecoveryConfig is not configured:
         6> increment SR_COUNTER by 1.
      4> else:
         5> notify RRC to release PUCCH for all Serving Cells;
         5> notify RRC to release SRS for all Serving Cells;
         5> clear any configured downlink assignments and uplink grants;
         5> clear any PUSCH resources for semi-persistent CSI reporting;
         5> initiate a Random Access procedure (see clause 5.1) on the SpCell and cancel all pending SRs.
   3> else:
      4> consider the SR transmission as a de-prioritized SR transmission.

The MAC entity may stop, if any, ongoing Random Access procedure due to a pending SR for BSR, which was initiated by the MAC entity prior to the MAC PDU assembly and which has no valid PUCCH resources configured, if:
a MAC PDU is transmitted using a UL grant other than a UL grant provided by Random Access Response or a UL grant determined as specified in clause 5.1.2a for the transmission of the MSGA payload, and this PDU includes a BSR MAC CE which contains buffer status up to (and including) the last event that triggered a BSR (see clause 5.4.5) prior to the MAC PDU assembly; or
the UL grant(s) can accommodate all pending data available for transmission.

The MAC entity may stop, if any, ongoing Random Access procedure due to a pending SR for SL-BSR and/or SL-CSI reporting and/or SL-DRX command indication, which was initiated by the MAC entity prior to the sidelink MAC PDU assembly and which has no valid PUCCH resources configured, if:
a MAC PDU is transmitted using a UL grant other than a UL grant provided by Random Access Response or a UL grant determined as specified in clause 5.1.2a for the transmission of the MSGA payload, and this PDU includes an SL-BSR MAC CE which contains buffer status up to (and including) the last event that triggered an SL-BSR (see clause 5.22.1.6) prior to the MAC PDU assembly; or
the SL grant(s) can accommodate all pending data available and/or SL-CSI reporting MAC CE and/or SL-DRX command indication for transmission.

The MAC entity may stop, if any, ongoing Random Access procedure due to a pending SR for BFR of an SCell, which has no valid PUCCH resources configured, if:
a MAC PDU is transmitted using a UL grant other than a UL grant provided by Random Access Response or a UL grant determined as specified in clause 5.1.2a for the transmission of the MSGA payload, and this PDU contains a MAC CE for BFR which includes beam failure recovery information of that SCell; or
the SCell is deactivated (as specified in clause 5.9) and all triggered BFRs for SCells are cancelled.

The MAC entity may stop, if any, ongoing Random Access procedure due to a pending SR for BFR of a BFD-RS set of a Serving Cell, which has no valid PUCCH resources configured, if:
a MAC PDU is transmitted using a UL grant other than a UL grant provided by Random Access Response or a UL grant determined as specified in clause 5.1.2a for the transmission of the MSGA payload, and this PDU contains an Enhanced BFR MAC CE or a Truncated Enhanced BFR MAC CE which includes beam failure recovery information of that BFD-RS set of the Serving Cell.

The MAC entity may stop, if any, ongoing Random Access procedure due to a pending SR for consistent LBT failure recovery, which has no valid PUCCH resources configured, if:
a MAC PDU is transmitted using a UL grant other than a UL grant provided by Random Access Response or a UL grant determined as specified in clause 5.1.2a for the transmission of the MSGA payload, and this PDU includes an LBT failure MAC CE that indicates consistent LBT failure for all the SCells that triggered consistent LBT failure; or
all the SCells that triggered consistent LBT failure recovery are deactivated (see clause 5.9).

The MAC entity may stop, if any, ongoing Random Access procedure due to a pending SR for positioning measurement gap activation/deactivation request, which has no valid PUCCH resources configured, if:
the Positioning Measurement Gap Activation/Deactivation Request MAC CE that triggers the SR corresponding to the Random Access procedure has already been cancelled.

The MAC entity may stop, if any, ongoing Random Access procedure due to a pending SR for Timing Advance report, which has no valid PUCCH resources configured, if:
a MAC PDU is transmitted using a UL grant other than a UL grant provided by Random Access Response or a UL grant determined as specified in clause 5.1.2a for the transmission of the MSGA payload, and this PDU includes a Timing Advance Report MAC CE (see clause 5.4.8).

### 5.18.4 Activation/Deactivation of UE-Specific PDSCH TCI State

The network may activate and deactivate the configured TCI states for PDSCH of a Serving Cell or a set of Serving Cells configured in simultaneousTCI-UpdateList1 or simultaneousTCI-UpdateList2 by sending the TCI States Activation/Deactivation for UE-specific PDSCH MAC CE described in clause 6.1.3.14. The network may activate and deactivate the configured TCI states for a codepoint of the DCI Transmission configuration indication field as specified in TS 38.212 [9] for PDSCH of a Serving Cell by sending the Enhanced TCI States Activation/Deactivation for UE-specific PDSCH MAC CE described in clause 6.1.3.24. The configured TCI states for PDSCH are initially deactivated upon (re-)configuration by upper layers and after reconfiguration with sync.

### The MAC Entity Shall:

1> if the MAC entity receives a TCI States Activation/Deactivation for UE-specific PDSCH MAC CE on a Serving Cell:
   2> indicate to lower layers the information regarding the TCI States Activation/Deactivation for UE-specific PDSCH MAC CE.
1> if the MAC entity receives an Enhanced TCI States Activation/Deactivation for UE-specific PDSCH MAC CE on a Serving Cell:
   2> indicate to lower layers the information regarding the Enhanced TCI States Activation/Deactivation for UE-specific PDSCH MAC CE.

### 5.18.5 Indication of TCI State for UE-Specific PDCCH

The network may indicate a TCI state for PDCCH reception for a CORESET of a Serving Cell or a set of Serving Cells configured in simultaneousTCI-UpdateList1 or simultaneousTCI-UpdateList2 by sending the TCI State Indication for UE-specific PDCCH MAC CE described in clause 6.1.3.15. The network may also indicate two TCI states for PDCCH reception for a CORESET of a Serving Cell or a set of Serving Cells configured in simultaneousTCI-UpdateList1 or simultaneousTCI-UpdateList2 by sending the Enhanced TCI States Indication for UE-specific PDCCH MAC CE described in clause 6.1.3.44.

### The MAC Entity Shall:

1> if the MAC entity receives a TCI State Indication for UE-specific PDCCH MAC CE on a Serving Cell:
   2> indicate to lower layers the information regarding the TCI State Indication for UE-specific PDCCH MAC CE.
1> if the MAC entity receives an Enhanced TCI States Indication for UE-specific PDCCH MAC CE on a Serving Cell:
   2> indicate to lower layers the information regarding the Enhanced TCI States Indication for UE-specific PDCCH MAC CE.

### 5.18.6 Activation/Deactivation of Semi-Persistent CSI Reporting on PUCCH

The network may activate and deactivate the configured Semi-persistent CSI reporting on PUCCH of a Serving Cell by sending the SP CSI reporting on PUCCH Activation/Deactivation MAC CE described in clause 6.1.3.16. The configured Semi-persistent CSI reporting on PUCCH is initially deactivated upon (re-)configuration by upper layers and after reconfiguration with sync.

### The MAC Entity Shall:

1> if the MAC entity receives an SP CSI reporting on PUCCH Activation/Deactivation MAC CE on a Serving Cell:
   2> indicate to lower layers the information regarding the SP CSI reporting on PUCCH Activation/Deactivation MAC CE.

### 5.18.7 Activation/Deactivation of Semi-Persistent SRS and Indication of Spatial Relation of SP/AP SRS

The network may activate and deactivate the configured Semi-persistent SRS resource sets of a Serving Cell by sending the SP SRS Activation/Deactivation MAC CE described in clause 6.1.3.17. The network may also activate and deactivate the configured Semi-persistent SRS resource sets of a Serving Cell by sending the Enhanced SP/AP SRS Spatial Relation Indication MAC CE described in clause 6.1.3.26. The network may also activate and deactivate the configured Semi-persistent SRS resource sets of a Serving Cell by sending the SP/AP SRS TCI State Indication MAC CE described in clause 6.1.3.59. The configured Semi-persistent SRS resource sets are initially deactivated upon (re-)configuration by upper layers and after reconfiguration with sync. The network may indicate the spatial relation info of SP/AP SRS resource sets of a Serving Cell by sending the Enhanced SP/AP SRS spatial relation Indication MAC CE described in clause 6.1.3.26.

### The MAC Entity Shall:

1> if the MAC entity receives an SP SRS Activation/Deactivation MAC CE on a Serving Cell:
   2> indicate to lower layers the information regarding the SP SRS Activation/Deactivation MAC CE.
1> if the MAC entity receives an Enhanced SP/AP SRS Spatial Relation Indication MAC CE on a Serving Cell:
   2> indicate to lower layers the information regarding the Enhanced SP/AP SRS Spatial Relation Indication MAC CE.
1> if the MAC entity receives an SP/AP SRS TCI State Indication MAC CE on a Serving Cell:
   2> indicate to lower layers the information regarding the SP/AP SRS TCI State Indication MAC CE.

### 5.18.8 Activation/Deactivation of Spatial Relation of PUCCH Resource

The network may activate and deactivate a spatial relation for a PUCCH resource of a Serving Cell by sending the PUCCH spatial relation Activation/Deactivation MAC CE described in clause 6.1.3.18. The network may also activate and deactivate a spatial relation for a PUCCH resource or a PUCCH resource group of a Serving Cell by sending the Enhanced PUCCH spatial relation Activation/Deactivation MAC CE described in clause 6.1.3.25. The configured spatial relation for a PUCCH resource is initially deactivated upon (re-)configuration by upper layers and after reconfiguration with sync. The network may also activate and deactivate the two spatial relations for a PUCCH resource or a PUCCH resource group of a Serving Cell by sending the PUCCH spatial relation Activation/Deactivation for multiple TRP PUCCH repetition MAC CE described in clause 6.1.3.45.

### The MAC Entity Shall:

1> if the MAC entity receives a PUCCH spatial relation Activation/Deactivation MAC CE on a Serving Cell:
   2> indicate to lower layers the information regarding the PUCCH spatial relation Activation/Deactivation MAC CE.
1> if the MAC entity receives an Enhanced PUCCH spatial relation Activation/Deactivation MAC CE on a Serving Cell:
   2> indicate to lower layers the information regarding the Enhanced PUCCH spatial relation Activation/Deactivation MAC CE.
1> if the MAC entity receives a PUCCH spatial relation Activation/Deactivation for multiple TRP PUCCH repetition MAC CE on a Serving Cell:
   2> indicate to lower layers the information regarding the PUCCH spatial relation Activation/Deactivation for multiple TRP PUCCH repetition MAC CE.

### 5.18.23 Unified TCI States Activation/Deactivation MAC CE

The network may activate and deactivate the configured unified TCI states of a Serving Cell or a set of Serving Cells configured in simultaneousU-TCI-UpdateList1, simultaneousU-TCI-UpdateList2, simultaneousU-TCI-UpdateList3 or simultaneousU-TCI-UpdateList4 by sending the Unified TCI States Activation/Deactivation MAC CE described in clause 6.1.3.47. The configured unified TCI states are initially deactivated upon (re-)configuration by upper layers and after reconfiguration with sync.

### The MAC Entity Shall:

1> if the MAC entity receives a Unified TCI States Activation/Deactivation MAC CE on a Serving Cell:
   2> indicate to lower layers the information regarding the Unified TCI States Activation/Deactivation MAC CE.

### 6.1.3.14 TCI States Activation/Deactivation for UE-Specific PDSCH MAC CE

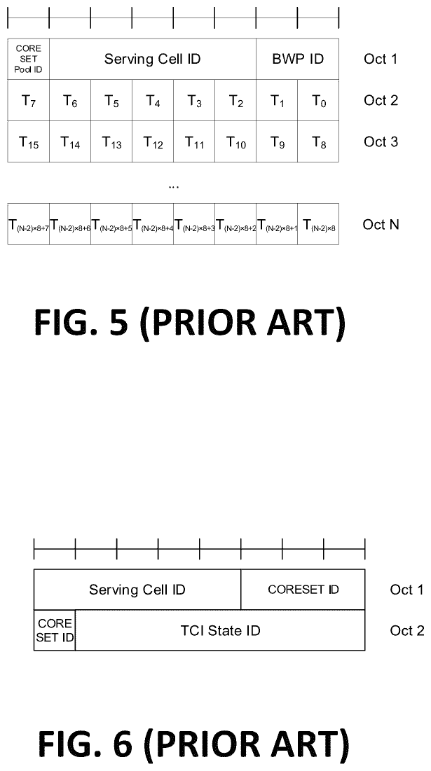

The TCI States Activation/Deactivation for UE-specific PDSCH MAC CE is identified by a MAC subheader with LCID as specified in Table 6.2.1-1. It has a variable size consisting of following fields:
Serving Cell ID: This field indicates the identity of the Serving Cell for which the MAC CE applies. The length of the field is 5 bits. If the indicated Serving Cell is configured as part of a simultaneousTCI-UpdateList1 or simultaneousTCI-UpdateList2 as specified in TS 38.331 [5], this MAC CE applies to all the Serving Cells configured in the set simultaneousTCI-UpdateList1 or simultaneousTCI-UpdateList2, respectively;
BWP ID: This field indicates a DL BWP for which the MAC CE applies as the codepoint of the DCI bandwidth part indicator field as specified in TS 38.212 [9]. The length of the BWP ID field is 2 bits. This field is ignored if this MAC CE applies to a set of Serving Cells;
Tᵢ: If there is a TCI state with TCI-StateId i as specified in TS 38.331 [5], this field indicates the activation/deactivation status of the TCI state with TCI-StateId i, otherwise MAC entity shall ignore the Tᵢ field. The Tᵢ field is set to 1 to indicate that the TCI state with TCI-StateId i shall be activated and mapped to the codepoint of the DCI Transmission Configuration Indication field, as specified in TS 38.214 [7]. The Tᵢ field is set to 0 to indicate that the TCI state with TCI-StateId i shall be deactivated and is not mapped to the codepoint of the DCI Transmission Configuration Indication field. The codepoint to which the TCI State is mapped is determined by its ordinal position among all the TCI States with Tᵢ field set to 1, i.e. the first TCI State with Tᵢ field set to 1 shall be mapped to the codepoint value 0, second TCI State with Tᵢ field set to 1 shall be mapped to the codepoint value 1 and so on. The maximum number of activated TCI states is 8. The activated TCI states can be associated with at most one PCI different from the Serving Cell PCI at a time;
CORESET Pool ID: This field indicates that mapping between the activated TCI states and the codepoint of the DCI Transmission Configuration Indication set by field Tᵢ is specific to the ControlResourceSetId configured with CORESET Pool ID as specified in TS 38.331 [5]. This field set to 1 indicates that this MAC CE shall be applied for the DL transmission scheduled by CORESET with the CORESET pool ID equal to 1, otherwise, this MAC CE shall be applied for the DL transmission scheduled by CORESET pool ID equal to 0. If the coresetPoolIndex is not configured for any CORESET, MAC entity shall ignore the CORESET Pool ID field in this MAC CE when receiving the MAC CE. If the Serving Cell in the MAC CE is configured in a cell list that contains more than one Serving Cell, the CORSET Pool ID field shall be ignored when receiving the MAC CE.
   FIG. 5 is a Reproduction of FIG. 6.1.3.14-1: TCI States Activation/Deactivation for UE-Specific PDSCH MAC CE, from 3GPP 38,321 v17.4.0.

### 6.1.3.15 TCI State Indication for UE-Specific PDCCH MAC CE

The TCI State Indication for UE-specific PDCCH MAC CE is identified by a MAC subheader with LCID as specified in Table 6.2.1-1. It has a fixed size of 16 bits with following fields:
Serving Cell ID: This field indicates the identity of the Serving Cell for which the MAC CE applies. The length of the field is 5 bits. If the indicated Serving Cell is configured as part of a simultaneousTCI-UpdateList1 or simultaneousTCI-UpdateList2 as specified in TS 38.331 [5], this MAC CE applies to all theServing Cells in the set simultaneousTCI-UpdateList1 or simultaneousTCI-UpdateList2, respectively;
CORESET ID: This field indicates a Control Resource Set identified with ControlResourceSetId as specified in TS 38.331 [5], for which the TCI State is being indicated. In case the value of the field is 0, the field refers to the Control Resource Set configured by controlResourceSetZero as specified in TS 38.331 [5]. The length of the field is 4 bits;
TCI State ID: This field indicates the TCI state identified by TCI-StateId as specified in TS 38.331 [5] applicable to the Control Resource Set identified by CORESET ID field. If the field of CORESET ID is set to 0, this field indicates a TCI-StateId for a TCI state of the first 64 TCI-states configured by tci-StatesToAddModList and tci-StatesToRelease List in the PDSCH-Config in the active BWP or by dl-OrJoint-TCI-State-ToAddModList and dl-OrJoint-TCI-State-ToReleaseList in the PDSCH-Config in the active BWP or the reference BWP. If the field of CORESET ID is set to the other value than 0, this field indicates a TCI-StateId configured by tci-StatesPDCCH-ToAddList and tci-StatesPDCCH-ToRelease List in the controlResourceSet identified by the indicated CORESET ID. The length of the field is 7 bits.
   FIG. 6 is a Reproduction of FIG. 6.1.3.15-1: TCI State Indication for UE-Specific PDCCH MAC CE, from 3GPP 38,321 v17.4.0.

### 6.1.3.18 PUCCH Spatial Relation Activation/Deactivation MAC CE

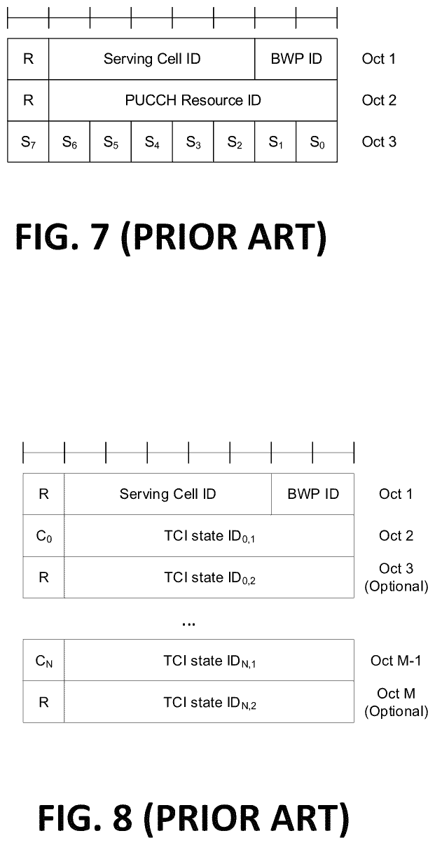

The PUCCH spatial relation Activation/Deactivation MAC CE is identified by a MAC subheader with LCID as specified in Table 6.2.1-1. It has a fixed size of 24 bits with following fields:
Serving Cell ID: This field indicates the identity of the Serving Cell for which the MAC CE applies. The length of the field is 5 bits;
BWP ID: This field indicates a UL BWP for which the MAC CE applies as the codepoint of the DCI bandwidth part indicator field as specified in TS 38.212 [9]. The length of the BWP ID field is 2 bits;
PUCCH Resource ID: This field contains an identifier of the PUCCH resource ID identified by PUCCH-ResourceId as specified in TS 38.331 [5]. The length of the field is 7 bits;
Sᵢ: If, in PUCCH-Config in which the PUCCH Resource ID is configured, there is a PUCCH Spatial Relation Info with PUCCH-SpatialRelationInfold as specified in TS 38.331 [5], configured for the uplink bandwidth part indicated by BWP ID field, Sᵢ indicates the activation status of PUCCH Spatial Relation Info with PUCCH-SpatialRelationInfold equal to i+1, otherwise MAC entity shall ignore this field. The Sᵢ field is set to 1 to indicate PUCCH Spatial Relation Info with PUCCH-SpatialRelationInfold equal to i+1 shall be activated. The Sᵢ field is set to 0 to indicate PUCCH Spatial Relation Info with PUCCH-SpatialRelationInfold equal to i+1 shall be deactivated. Only a single PUCCH Spatial Relation Info can be active for a PUCCH Resource at a time;
R: Reserved bit, set to 0.
   FIG. 7 is a Reproduction of FIG. 6.1.3.18-1: PUCCH Spatial Relation Activation/Deactivation MAC CE, from 3GPP 38,321 v17.4.0.

### 6.1.3.24 Enhanced TCI States Activation/Deactivation for UE-specific PDSCH MAC CE

The Enhanced TCI States Activation/Deactivation for UE-specific PDSCH MAC CE is identified by a MAC PDU subheader with eLCID as specified in Table 6.2.1-1b. It has a variable size consisting of following fields:
Serving Cell ID: This field indicates the identity of the Serving Cell for which the MAC CE applies. The length of the field is 5 bits. If the indicated Serving Cell is configured as part of a simultaneousTCI-UpdateList1 or simultaneousTCI-UpdateList2 as specified in TS 38.331 [5], this MAC CE applies to all the Serving Cells configured in the set simultaneousTCI-UpdateList1 or simultaneousTCI-UpdateList2, respectively;
BWP ID: This field indicates a DL BWP for which the MAC CE applies as the codepoint of the DCI bandwidth part indicator field as specified in TS 38.212 [9]. The length of the BWP ID field is 2 bits;
Cᵢ: This field indicates whether the octet containing TCI state ID_{i,2} is present. If this field is set to 1, the octet containing TCI state ID_{i,2} is present. If this field is set to 0, the octet containing TCI state ID_{i,2} is not present;
TCI state ID_{i,j}: This field indicates the TCI state identified by TCI-StateId as specified in TS 38.331 [5], where i is the index of the codepoint of the DCI Transmission configuration indication field as specified in TS 38.212 [9] and TCI state ID_{i,j} denotes the j^{th} TCI state indicated for the i^{th} codepoint in the DCI Transmission Configuration Indication field. The TCI codepoint to which the TCI States are mapped is determined by its ordinal position among all the TCI codepoints with sets of TCI state ID_{i,j} fields, i.e. the first TCI codepoint with TCI state ID_{0,1} and TCI state ID_{0,2} shall be mapped to the codepoint value 0, the second TCI codepoint with TCI state ID_{1,1} and TCI state ID_{1,2} shall be mapped to the codepoint value 1 and so on. The TCI state ID_{i,2} is optional based on the indication of the CH field. The maximum number of activated TCI codepoint is 8 and the maximum number of TCI states mapped to a TCI codepoint is 2.
R: Reserved bit, set to 0.
   FIG. 8 is a Reproduction of FIG. 6.1.3.24-1: Enhanced TCI States Activation/Deactivation for UE-Specific PDSCH MAC CE, from 3GPP 38,321 v17.4.0.

### 6.1.3.25 Enhanced PUCCH Spatial Relation Activation/Deactivation MAC CE

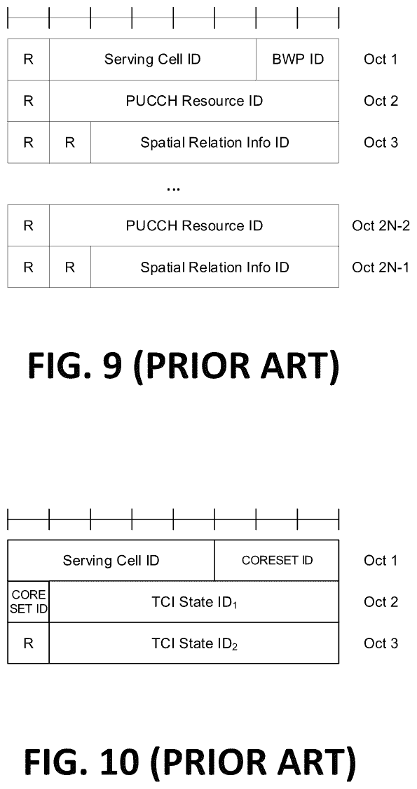

The Enhanced PUCCH Spatial Relation Activation/Deactivation MAC CE is identified by a MAC subheader with eLCID as specified in Table 6.2.1-1b. It has a variable size with following fields:
Serving Cell ID: This field indicates the identity of the Serving Cell for which the MAC CE applies. The length of the field is 5 bits;
BWP ID: This field indicates a UL BWP for which the MAC CE applies as the codepoint of the DCI bandwidth part indicator field as specified in TS 38.212 [9]. The length of the BWP ID field is 2 bits;
PUCCH Resource ID: This field contains an identifier of the PUCCH resource ID identified by PUCCH-ResourceId as specified in TS 38.331 [5], which is to be activated with a spatial relation indicated by Spatial Relation Info ID field in the subsequent octet. The length of the field is 7 bits. If the indicated PUCCH Resource ID is included in a PUCCH Resource Group (configured via resourceGroupToAddModList as specified in TS 38.331 [5]) of the indicated UL BWP, no other PUCCH Resources within the same PUCCH Resource group are indicated in the MAC CE, and this MAC CE applies to all the PUCCH Resources in the PUCCH Resource group;
Spatial Relation Info ID: This field contains PUCCH-SpatialRelationInfold-1 where PUCCH-SpatialRelationInfold is the identifier of the PUCCH Spatial Relation Info in PUCCH-Config in which the PUCCH Resource ID is configured, as specified in TS 38.331 [5]. The length of the field is 6 bits;
R: Reserved bit, set to 0.
   FIG. 9 is a Reproduction of FIG. 6.1.3.25-1: Enhanced PUCCH Spatial Relation Activation/Deactivation MAC CE, from 3GPP 38,321 v17.4.0.

### 6.1.3.44 Enhanced TCI States Indication for UE-Specific PDCCH MAC CE

The Enhanced TCI States Indication for UE-specific PDCCH MAC CE is identified by a MAC PDU subheader with eLCID as specified in Table 6.2.1-1b. It has a fixed size of 24 bits with following fields:
Serving Cell ID: This field indicates the identity of the Serving Cell for which the MAC CE applies. The length of the field is 5 bits. If the indicated Serving Cell is configured as part of a simultaneousTCI-UpdateList1 or simultaneousTCI-UpdateList2 as specified in TS 38.331 [5], this MAC CE applies to all theServing Cells in the set simultaneousTCI-UpdateList1 or simultaneousTCI-UpdateList2, respectively;
CORESET ID: This field indicates a Control Resource Set identified with ControlResourceSetId as specified in TS 38.331 [5], for which the TCI State is being indicated. In case the value of the field is 0, the field refers to the Control Resource Set configured by controlResourceSetZero as specified in TS 38.331 [5]. The length of the field is 4 bits;
TCI state IDi: This field indicates the TCI state identified by TCI-StateId as specified in TS 38.331 [5] applicable to the Control Resource Set identified by CORESET ID field. If the field of CORESET ID is set to the other value than 0, this field indicates a TCI-StateId configured by tci-StatesPDCCH-ToAddList and tci-StatesPDCCH-ToReleaseList in the controlResourceSet identified by the indicated CORESET ID. The length of the field is 7 bits.
NOTE 1: The Enhanced TCI State Indication for UE specific PDCCH MAC CE is not applicable to any of the configured CORESETs in a BWP if the CORESETs are configured with different CORESETPoolindex values in the BWP.
NOTE 2: The Enhanced TCI State Indication for UE specific PDCCH MAC CE is applied only if sfnSchemePdcch is configured.
NOTE 3: The Enhanced TCI State Indication for UE specific PDCCH MAC CE is not applicable to the CORESET configured by controlResourceSetZero if the CORESET is associated with the search space configured by pdcch-ConfigSIB1 in MIB, or searchSpaceSIB1, searchSpaceZero, searchSpaceOtherSystemInformation, or pagingSearchSpace in PDCCH-ConfigCommon.
   FIG. 10 is a Reproduction of FIG. 6.1.3.44-1: Enhanced TCI States Indication for UE-Specific PDCCH MAC CE, from 3GPP 38,321 v17.4.0.

### 6.1.3.47 Unified TCI States Activation/Deactivation MAC CE

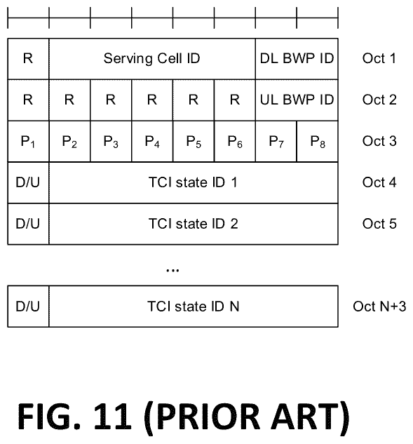

The Unified TCI States Activation/Deactivation MAC CE is identified by a MAC subheader with eLCID as specified in Table 6.2.1-1b. It has a variable size consisting of following fields:
Serving Cell ID: This field indicates the identity of the Serving Cell for which the MAC CE applies. The length of the field is 5 bits. If the indicated Serving Cell is configured as part of a simultaneousU-TCI-UpdateList1, simultaneousU-TCI-UpdateList2, simultaneousU-TCI-UpdateList3 or simultaneousU-TCI-UpdateList4 as specified in TS 38.331 [5], this MAC CE applies to all theServing Cells in the set simultaneousU-TCI-UpdateList1, simultaneousU-TCI-UpdateList2, simultaneousU-TCI-UpdateList3 or simultaneousU-TCI-UpdateList4, respectively;
DL BWP ID: This field indicates a DL BWP for which the MAC CE applies as the codepoint of the DCI bandwidth part indicator field as specified in TS 38.212 [9]. The length of the BWP ID field is 2 bits;
UL BWP ID: This field indicates a UL BWP for which the MAC CE applies as the codepoint of the DCI bandwidth part indicator field as specified in TS 38.212 [9]. If value of unifiedTCI-StateType in the Serving Cell indicated by Serving Cell ID is joint, this field is considered as the reserved bits. The length of the BWP ID field is 2 bits;
Pᵢ: This field indicates whether each TCI codepoint has multiple TCI states or single TCI state. If Pᵢ field is set to 1, it indicates that i^{th} TCI codepoint includes the DL TCI state and the UL TCI state. If Pᵢ field is set to 0, it indicates that i^{th} TCI codepoint includes only the DL/joint TCI state or the UL TCI state. The codepoint to which a TCI state is mapped is determined by its ordinal position among all the TCI state ID fields;
D/U: This field indicate whether the TCI state ID in the same octet is for joint/downlink or uplink TCI state. If this field is set to 1, the TCI state ID in the same octet is for joint/downlink. If this field is set to 0, the TCI state ID in the same octet is for uplink;
TCI state ID: This field indicates the TCI state identified by TCI-StateId as specified in TS 38.331 [5]. If D/U is set to 1, 7-bits length TCI state ID i.e. TCI-StateId as specified in TS 38.331 [5] is used. If D/U is set to 0, the most significant bit of TCI state ID is considered as the reserved bit and remainder 6 bits indicate the TCI-UL-State-Id as specified in TS 38.331 [5]. The maximum number of activated TCI states is 16;
R: Reserved bit, set to 0.
   FIG. 11 is a Reproduction of FIG. 6.1.3.47-1: Unified TCI State Activation/Deactivation MAC CE, from 3GPP 38,321 v17.4.0.

In 38.331 ([3] 3GPP 38,331 v17.4.0), TCI state configuration for Uplink and Downlink are introduced:

### PDSCH-Config

The PDSCH-Config IE is used to configure the UE specific PDSCH parameters.

PDSCH-Config information element

-- ASN1START
-- TAG-PDSCH-CONFIG-START

| | |
|---|---|
| PDSCH-Config ::= | SEQUENCE { |
| dataScramblingIdentityPDSCH | INTEGER (0..1023) |

OPTIONAL, -- Need S

| | |
|---|---|
| dmrs-DownlinkForPDSCH-MappingTypeA | SetupRelease { DMRS-DownlinkConfig } |

OPTIONAL, -- Need M

| | |
|---|---|
| dmrs-DownlinkForPDSCH-MappingTypeB | SetupRelease { DMRS-DownlinkConfig } |

OPTIONAL, -- Need M

| | |
|---|---|
| tci-StatesToAddModList | SEQUENCE (SIZE(1..maxNrofTCI-States)) OF TCI-State |

OPTIONAL, -- Need N

| | |
|---|---|
| tci-StatesToReleaseList | SEQUENCE (SIZE(1..maxNrofTCI-States)) OF TCI-StateId |

OPTIONAL, -- Need N
...

tci-StatesToAddModList
A list of Transmission Configuration Indicator (TCI) states
indicating a transmission configuration which includes QCL-
relationships between the DL RSs in one RS set and the PDSCH
DMRS ports (see TS 38.214 [19], clause 5.1.5). If
unifiedTCI-StateType is configured for the serving cell,
no element in this list is configured.

### ControlResourceSet

The IE ControlResourceSet is used to configure a time/frequency control resource set (CORESET) in which to search for downlink control information (see TS 38.213 [13], clause 10.1).

ControlResourceSet information element

-- ASN1START
-- TAG-CONTROLRESOURCESET-START

| | |
|---|---|
| ControlResourceSet ::= | SEQUENCE { |
| controlResourceSetId | ControlResourceSetId, |
| frequencyDomainResource | BIT STRING (SIZE (45)), |
| duration | INTEGER (1..maxCoReSetDuration), |
| cce-REG-MappingType | CHOICE { |
| interleaved | SEQUENCE { |
| reg-BundledSize | ENUMERATED {n2, n3, n6}, |
| interleaverSize | ENUMERATED {n2, n3, n6}, |
| shiftIndex | INTEGER(0..maxNrofPhysicalResourceBlocks-1) |

OPTIONAL -- Need S
},

| | |
|---|---|
| nonInterleaved | NULL |

},

| | |
|---|---|
| precoderGranularity | ENUMERATED {sameAsREG-bundle, allContiguousRBs}, |
| tci-StatesPDCCH-ToAddList | SEQUENCE(SIZE (1..maxNrofTCI-StatesPDCCH)) OF TCI-StateId |

OPTIONAL, -- Cond NotSIB-initialBWP

| | |
|---|---|
| tci-StatesPDCCH-ToReleaseList | SEQUENCE(SIZE (1..maxNrofTCI-StatesPDCCH)) OF TCI-StateId |

OPTIONAL, -- Cond NotSIB-initialBWP

| | |
|---|---|
| tci-PresentInDCI | ENUMERATED {enabled} |

OPTIONAL, -- Need S

tci-StatesPDCCH-ToAddList
A subset of the TCI states defined in pdsch-Config, either with tci-
StatesToAddModList or dl-OrJointTCI-StateList, included in the BWP-
DownlinkDedicated corresponding to the serving cell and to the DL
BWP to which the ControlResourceSet belong to. They are used for
providing QCL relationships between the DL RS(s) in one RS Set
(TCI-State) and the PDCCH DMRS ports (see TS 38.213 [13], clause 6.).
The network configures at most maxNrofTCI-StatesPDCCH entries.
The QCL relationships defined herein do not apply to MBS broadcast.

### BWP-UplinkDedicated

The IE BWP-UplinkDedicated is used to configure the dedicated (UE specific) parameters of an uplink BWP.

BWP-UplinkDedicated information element

...

| | |
|---|---|
| BWP-UplinkDedicated ::= | SEQUENCE { |
| pucch-Config | SetupRelease { PUCCH-Config } |

OPTIONAL, -- Need M

| | |
|---|---|
| pusch-Config | SetupRelease { PUSCH-Config } |

OPTIONAL, -- Need M

| | |
|---|---|
| configuredGrantConfig | SetupRelease { ConfiguredGrantConfig } |

OPTIONAL, -- Need M

| | |
|---|---|
| srs-Config | SetupRelease { SRS-Config } |

OPTIONAL, -- Need M

| | |
|---|---|
| beamFailureRecoveryConfig | SetupRelease { BeamFailureRecoveryConfig } |

```
OPTIONAL, -- Cond SpCellOnly
  ...,
  [[
```

| | |
|---|---|
| sl-PUCCH-Config-r16 | SetupRelease { PUCCH-Config } |

OPTIONAL, -- Need M

| | |
|---|---|
| cp-ExtensionC2-r16 | INTEGER (1..28) |

OPTIONAL, -- Need R

| | |
|---|---|
| cp-ExtensionC3-r16 | INTEGER (1..28) |

OPTIONAL, -- Need R

| | |
|---|---|
| useInterlacePUCCH-PUSCH-r16 | ENUMERATED {enabled} |

OPTIONAL, -- Need R

| | |
|---|---|
| pucch-ConfiguratonList-r16 | SetupRelease { PUCCH-ConfigurationList-r16 } |

OPTIONAL, -- Need M

| | |
|---|---|
| lbt-FailureRecoveryConfig-r16 | SetupRelease { LBT-FailureRecoveryConfig-r16 } |

OPTIONAL, -- Need M

| | |
|---|---|
| configuredGrantConfigToAddModList-r16 | ConfiguredGrantConfigToAddModList-r16 |

OPTIONAL, -- Need N

| | |
|---|---|
| configuredGrantConfigToReleaseList-r16 | ConfiguredGrantConfigToReleaseList-r16 |

OPTIONAL, -- Need N
configuredGrantConfigType2DeactivationStateList-r16

| | |
|---|---|
| ConfiguredGrantConfigType2DeactivationStateList-r16 | OPTIONAL -- Need R |

```
  ]],
  [[
```

| ul-TCI-StateList-r17 | | CHOICE { |
|---|---|---|
| explicitlist | | SEQUENCE { |
| | ul-TCI-ToAddModList-r17 | SEQUENCE (SIZE (1..maxUL-TCI-r17)) OF TCI-UL-State- |
| r17 | OPTIONAL, -- Need N | |
| | ul-TCI-ToReleaseList-r17 | SEQUENCE (SIZE (1..maxUL-TCI-r17)) OF TCI-UL-StateId- |

| | |
|---|---|
| r17 | OPTIONAL -- Need N |

},

| | |
|---|---|
| unifiedTCI-StateRef-r17 | ServingCellAndBWP-Id-r17 |

}
OPTIONAL, -- Need R

ul-TCI-StateList
Indicates the applicable UL TCI states for PUCCH, PUSCH and SRS.
ul-TCI-ToAddModList
Indicates a list of UL TCI states.

### TCI-State

The IE TCI-State associates one or two DL reference signals with a corresponding quasi-colocation (QCL) type.

TCI-State information element

...

| | |
|---|---|
| TCI-State ::= | SEQUENCE { |
| tci-StateId | TCI-StateId, |
| qcl-Type1 | QCL-Info, |
| qcl-Type2 | QCL-Info |

```
OPTIONAL, -- Need R
  ...,
  [[
```

| | |
|---|---|
| additionalPCI-r17 | AdditionalPCIIndex-r17 |

OPTIONAL, -- Need R

| | |
|---|---|
| pathlossReferenceRS-Id-r17 | PathlossReferenceRS-Id-r17 |

OPTIONAL, -- Cond JointTCI1

| | |
|---|---|
| ul-powerControl-r17 | Uplink-powerControlId-r17 |

OPTIONAL -- Cond JointTCI
]]
}

| | |
|---|---|
| QCL-Info ::= | SEQUENCE { |
| cell | ServCellIndex |

OPTIONAL, -- Need R

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}
...

TCI-State field descriptions

additionalPCI
Indicates the physical cell IDs (PCI) of the SSBs when referenceSignal is configured as SSB for both QCL-Type1 and
QCL-Type2. In case the cell is present, the additionalPCI refers to a PCI value configured in the list configured using
additionalPCI-ToAddModList in the serving cell indicated by the field cell. Otherwise, it refers to a PCI value configured
in a list additionalPCI-ToAddModList configured in the serving cell where the TCI-State is applied by the UE. When this
field is present the cell for qcl-Type1 and qcl-Type2 is configured with same value, if present.
pathlossReferenceRS-Id
The ID of the reference signal (e.g. a CSI-RS or an SS block) used for PUSCH, PUCCH and SRS path loss estimation.
This field refers to an element in the list configured using pathlossReferenceRSToAddModList in the serving cell and UL
BWP where the TCI State is applied by the UE.
qcl-Type1, qcl-Type2
QCL information for the TCI state as specified in TS 38.214 [19] clause 5.1.5.
tci-StateId
ID number of the TCI state.
ul-PowerControl
Configures power control parameters for PUCCH, PUSCH and SRS for this TCI state. The field is present here only if
ul-powerControl is not configured in any BWP-Uplink-Dedicated of this serving cell. This field refers to an element in the
list configured using uplink-PowerControlToAddModList in the serving cell where the dl-OrJointTCI-StateToAddModList
is configured.

### TCI-StateId

The IE TCI-StateId is used to identify one TCI-State configuration.

TCI-StateId information element

...
TCI-StateId ::= INTEGER (0..maxNrofTCI-States-1)
...

### TCI-UL-State

The IE TCI-UL-State indicates the TCI state information for UL transmission.

TCI-UL-State information element

| TCI-UL-State-r17 ::= | SEQUENCE { | |
|---|---|---|
| tci-UL-StateId-r17 | TCI-UL-StateId-r17, | |
| servingCellId-r17 | ServCellIndex | OPTIONAL, |

-- Need R

| | | |
|---|---|---|
| bwp-Id-r17 | BWP-Id | OPTIONAL, |

-- Cond CSI-RSorSRS-Indicated

| | |
|---|---|
| referenceSignal-r17 | CHOICE { |
| ssb-Index-r17 | SSB-Index, |
| csi-RS-Index-r17 | NZP-CSI-RS-ResourceId, |
| srs-r17 | SRS-ResourceId |

},

| | | |
|---|---|---|
| additionalPCI-r17 | AdditionalPCIIndex-r17 | OPTIONAL, |

-- Need R

| | | |
|---|---|---|
| ul-powerControl-r17 | Uplink-powerControlId-r17 | OPTIONAL, |

-- Need R

| | | |
|---|---|---|
| pathlossReferenceRS-Id-r17 | PathlossReferenceRS-Id-r17 | OPTIONAL, |

-- Cond Mandatory
...
}

TCI-UL-State field descriptions

additionalPCI
Indicates the physical cell IDs (PCI) of the SSBs when referenceSignal is configured as SSB. In case the servingCellId
is present, the additionalPCI refers to a PCI value configured in the list configured using additionalPCI-ToAddModList in
the serving cell indicated by the field servingCellId. Otherwise, it refers to a PCI value configured in the list configured
using additionalPCI-ToAddModList in the serving cell where the ul-TCI-StateList is applied by the UE.
bwp-Id
The DL BWP which the CSI-RS is located in or UL BWP where the SRS is located in.
servingCellId
The UE's serving cell in which the referenceSignal is configured. If the field is absent, it applies to the serving cell in
which the TCI-UL-State is applied by the UE.
pathlossReferenceRS-Id
The ID of the reference Signal (e.g. a CSI-RS or a SS block) used for PUSCH, PUCCH and SRS path loss estimation.
This field refers to an element in the list configured using pathlossReferenceRSToAddModList in the serving cell and UL
BWP where the UL TCI State is applied by the UE.

### TCI-UL-StateId

The IE TCI-UL-StateId is used to identify one TCI-UL-State configuration.

In 3GPP spec 38.300 running CR for introduction of NR further mobility enhancements (e.g., [4] R2-2213332 38.300 running CR for introduction of NR further mobility enhancements), L1/L2-triggered mobility (LTM) is introduced:

### 9.2.3.x L1/L2-Triggered Mobility

### 9.2.3.x.1 General

LTM is a procedure in which a gNB receives L1 measurement reports from UEs, and on their basis the gNB changes UEs' serving cell(s) through MAC CE. The gNB prepares one or multiple candidate cells and provides the candidate cell configurations to the UE through RRC message. Then LTM cell switch is triggered, by selecting one of the candidate configurations as target configuration for LTM by the gNB. The candidate cell configurations can only be added, modified and released by network via RRC signaling.

Editors' note: FFS later whether some optimization should be applied e.g. for release.

Editor's note: Current options to configure a LTM candidate cell:
a. One RRCReconfiguration message for candidate target cell
b. One CellGroupConfig IE for each candidate target cell

The following principles apply to LTM:
Candidate cell configuration can be provided as delta configurations on top of a reference configuration. The reference configuration is managed separately, and a UE stores the reference configuration as a separate configuration.
   User plane is continued whenever possible (e.g. intra-DU), without reset, with the target to avoid data loss and the additional delay of data recovery.
      Security is not updated in LTM.
      Subsequent LTM between candidates (i.e., UE does not release other candidate cell configurations after LTM is triggered) can be performed without RRC reconfiguration.

LTM supports both intra-gNB-DU and intra-gNB-CU inter-gNB-DU mobility. LTM also supports inter-frequency mobility, including mobility to inter-frequency cell that is not a current serving cell. The following scenarios are supported:
PCell change in non-CA scenario,
PCell change without SCell change in CA scenario,
PCell change with SCell change(s) in CA scenario, including the following cases:
   a) The target PCell/target SCell(s) is not a current serving cell (CA-to-CA scenario with PCell change)
   b) The target PCell is a current SCell
   c) The target SCell is the current PCell.
Dual connectivity scenario, at least for the PSCell change without MN involvement case, i.e. intra-SN.

Inter-cell beam management is also supported, but is not considered as a prerequisite for using LTM.

Editor's note: The design for intra-DU and inter-DU L1/L2-based mobility should share as much commonality as reasonable. FFS which aspects need to be different.

Editor's note: FFS whether ASN.1 decoding and validity/compliance check of candidate cell configuration are performed upon reception of the candidate cells configuration, and if this needs to be specified.

### 9.2.3.x.2 C-Plane Handling

Cell switch trigger information is conveyed in a MAC CE, which contains at least a candidate configuration index. Cell-specific, radio bearer, and measurement configurations can be part of an LTM candidate cell configuration.

Editor's note: FFS if the MAC CE can indicate TCI state(s) (or other beam info) to be activate for the target Cell(s)

Editor's note: FFS if it should be possible to perform SCell activation/deactivation (amongst SCells associated with the candidate configuration) simultaneously with the LTM triggering MAC CE.

UE may perform CBRA or CFRA at cell switch. UE may also skip random access procedure if UE doesn't need to acquire TA for the target cell during cell switch. RACH resources for CFRA are provided in RRC configuration.

Editor's note: FFS if the CFRA resources can be provide via MAC CE.

The overall procedure for LTM is shown in Figure x below. Subsequent LTM is done by repeating the early synchronization, LTM execution, and LTM completion steps without releasing other candidates after each LTM completion.

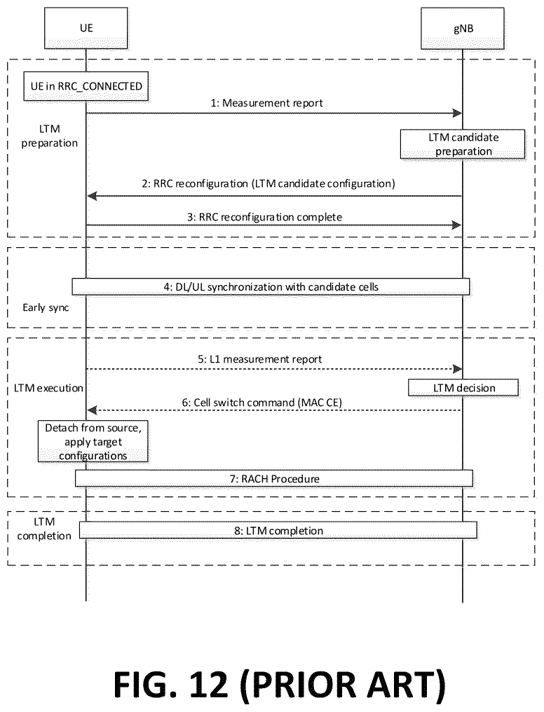

FIG. 12 is a Reproduction of Figure x, Signaling Procedure for LTM, from R2-2213332 38.300 Running CR for introduction of NR further mobility enhancements.

The procedure for LTM is as follows.
1. The UE sends a MeasurementReport message to the gNB. The gNB decides to use LTM and initiates LTM candidate preparation.
2. The gNB transmits an RRCReconfiguration message to the UE including the configuration of one or multiple LTM candidate target cells.
3. The UE stores the configuration of LTM candidate target cell(s) and transmits a RRCReconfigurationComplete message to the gNB.
4. The UE may perform DL synchronization and TA acquisition with candidate target cell(s) before receiving the LTM cell switch command.

Editor's note: DL synchronization for candidate cell(s) before cell switch command is supported, at least based on SSB. FFS necessary mechanism.

Editor's note: TA acquisition of candidate cell(s) before LTM cell switch command is supported, at least based on PDCCH ordered RACH, where the PDCCH order is only triggered by source cell. FFS detailed mechanism.
5. The UE performs L1 measurements on the configured LTM candidate target cell(s), and transmits lower-layer measurement reports to the gNB.
6. The gNB decides to execute LTM cell switch to a target cell, and transmits a MAC CE triggering LTM cell switch by including the candidate configuration index of the target cell. The UE switches to the configuration of the LTM candidate target cell.

Editor's note: FFS how beam indication is done.
7. The UE performs random access procedure towards the target cell, if TA is not available.
8. The UE indicates successful completion of the LTM cell switch towards target cell.

uplink signal or message after the UE has switched to the target cell is used to indicate successful completion of the LTM cell switch.

### 9.2.3.x.3 U-Plane Handling

In LTM, whether the UE performs partial or full MAC reset, re-establish RLC, performs data recovery with PDCP during cell swith is explicitly controlled by the network.

Editor's note: ON the determination of whether to reset L2: two options on the table:
1) The UE determines whether the switch is intra DU or inter DU and the follows different rule or configuration for these two cases which controls whether to reset or not reset. Determination could be based on configuration (e.g. of a DU ID, cell group id etc.)
2) The UE receives command to reset or not reset by MAC CE.

In New Radio (NR), in order to perform communication (on high frequency band) while maintaining a wide communication range, beam forming and beam communication is introduced. A network and a User Equipment (UE) perform communication via beam (e.g. Synchronization Signal Block (SSB) or Channel State Information Reference Signal (CSI-RS) or are associated with Transmission Configuration Indicator (TCI) state(s)). The UE could be configured with one or more TCI state(s) for beam communication. The UE could (be indicated to) activate TCI state(s) or beam(s) to perform Downlink (DL) communication (e.g., Physical Downlink Control Channel (PDCCH)/Physical Downlink Shared Channel (PDSCH)) or Uplink (UL) communication (e.g., Physical Uplink Control Channel (PUCCH)/Physical Uplink Shared Channel (PUSCH)). The UE could be configured with measurement configuration(s) for beam(s). The UE could monitor and/or measure SSB or CSI-RS and perform L1 reporting (e.g., L1-Reference Signal Received Power (RSRP) or L1-Signal to Interference plus Noise Ratio (SINR) reporting) to the network indicating beam quality. The network could determine whether to perform beam change for the UE based on at least the L1 reporting. The measurement could be periodic measurement reporting or aperiodic measurement reporting triggered/requested by the network. With rapid or unexpected beam changes, the network may not be able to acknowledge the beam change in time with periodic/aperiodic beam reporting.

In order to reduce latency in beam update regarding rapid beam changes, UE-initiated beam reporting and/or beam switching/update could be used. For example, the UE could determine to trigger a beam reporting based on beam quality (e.g., (activated) beam quality being lower than a threshold). The beam reporting could be or could indicate a request of a beam update. The beam reporting could contain or indicate a (candidate) beam with beam quality over a threshold (e.g., beam with highest quality among configured/measured beams). Additionally and/or alternatively, the UE could determine to perform beam switching (e.g., update its (activated) beam) based on at least the quality of beam(s). Additionally and/or alternatively, the UE could update and/or change its (activated) beam in response to transmitting (UE-initiated) beam reporting. While a UE-initiated beam reporting and beam switching/update could reduce latency for beam change, one possible issue could occur when the beam update status is not synchronized between the network and the UE, or the beam update status is not indicated successfully to the network. For example, the UE could indicate the beam reporting/switching to the network while the network indicates a beam update at the same time, or the network does not receive or does not acknowledge the beam reporting/switching initiated by the UE.

With the present invention, methods regarding error handling and conflict resolving regarding UE-initiated beam reporting and beam switching is introduced and addressed.

One concept of the present invention is that a UE could determine whether a UE-initiated beam switching procedure (associated with a Cell) is successful based on whether a beam switching indication (of the Cell) (triggered/generated by the UE-initiated beam switching) is successfully received by a network (or successfully transmitted to the network). The UE could consider the UE-initiated beam switching procedure (of a DL or UL channel) (of a Cell) to be successful if or when the beam switching indication (of the DL or UL channel) (of the Cell) is successfully received by the network (or successfully transmitted to the network). The UE could consider the UE-initiated beam switching procedure (of a DL or UL channel) (of a Cell) to be failed or not successful if or when the beam switching indication (of the DL or UL channel) (of the Cell) associated with the UE-initiated beam switching procedure is not successfully received by the network (or not successfully transmitted to the network).

Additionally and/or alternatively, the UE could perform UE-initiated beam switching based on whether a beam switching indication (associated with the UE-initiated beam switching) is successfully received by a network (or (successfully) transmitted to the network). For example, the UE could perform UE-initiated beam switching to a first beam after (e.g., after a configured or fixed time period) successfully transmitting the beam switching indication (indicating the first beam). The first beam could be a beam selected by the UE (based on beam quality).

Additionally and/or alternatively, the UE could perform UE-initiated beam switching based on whether the UE-initiated beam switching procedure is successfully completed.

The UE could trigger a UE-initiated beam switching (procedure) (of a DL or UL channel) (of a Cell) in response to a beam quality of a current (activated) beam (of the DL or UL channel) (of the Cell) is lower than or equal to a threshold. The UE could perform UE-initiated beam switching during or after a UE-initiated beam switching procedure. The UE-initiated beam switching procedure could contain the UE transmitting the beam switching indication to the network. The UE could cancel a triggered UE-initiated switching trigger when or if the UE-initiated beam switching procedure is successfully completed or the beam switching indication is successfully transmitted to the network. When performing UE-initiated beam switching (in or after a UE-initiated beam switching procedure), the UE could apply a beam (selected by the UE) or change a (activated) beam for a DL and/or UL channel to a selected beam. The selected beam could be indicated in the beam switching indication transmitted to the network. When applying a beam (on a DL or UL channel), the UE could activate the beam (for the DL or UL channel) and the UE could deactivate one or more current (or previous) beams (that were activated and not deactivated before applying the beam) (for the DL or UL channel). The UE-initiated beam switching procedure could contain the UE switching to a configuration of a L1/L2-Triggered Mobility (LTM) candidate cell. The UE-initiated beam switching procedure could contain the UE switching to a configuration of a LTM candidate cell in response to transmitting a beam switching indication associated with the LTM candidate cell to the network. The UE could execute LTM cell switch to the LTM candidate cell in response to transmitting the beam switching indication or in response to successful completion of a UE-initiated beam switching procedure including transmitting the beam switching indication. The UE could be configured with measurement resource(s) and/or measurement configuration(s) associated with the LTM candidate cell. The UE could trigger to transmit the beam switching indication associated with the LTM candidate cell in response to a beam quality or when an L1 measurement on the LTM candidate cell is higher than or equal to a threshold (and a beam quality or an L1 measurement of a Primary Cell (PCell) or Special Cell (SpCell) is lower than or equal to a threshold).

The UE may execute an LTM cell switch to the LTM candidate cell without a network indication (e.g., Cell switch command). Alternatively, the UE could execute an LTM cell switch to the LTM candidate cell in response to a network indication (e.g., positive feedback of beam switching indication).

Additionally and/or alternatively, the beam switching indication associated with the LTM candidate cell could contain or indicate candidate configuration (e.g., candidate configuration index) associated with the LTM candidate cell. Additionally and/or alternatively, the beam switching indication associated with the LTM candidate cell may not indicate a beam or beam quality associated with the LTM candidate cell.

Additionally and/or alternatively, the beam switching indication could be transmitted to the LTM candidate cell. Additionally and/or alternatively, the beam switching indication could be transmitted to the SpCell or the source cell or the UE.

The beam switching indication could indicate beam(s) of candidate cell(s) (associated with candidate configuration of LTM). Alternatively, the beam switching indication may not indicate beam(s) not associated with Serving Cell(s).

### Acknowledgement (ACK)/Timer-Based

Additionally and/or alternatively, the UE could determine whether a beam switching indication is successfully received by a network (or (successfully) transmitted to the network) based on a feedback from the network. The UE could determine whether the beam switching procedure is successfully completed based on a feedback from the network. The UE could consider the UE-initiated beam switching procedure to be successful if or when receiving a (positive) feedback associated with the beam switching indication from the network. The UE could consider the UE-initiated beam switching procedure to be successful if or when receiving a (negative) feedback associated with the beam switching indication from the network. Alternatively, the UE could consider the UE-initiated beam switching procedure to be not successful if or when receiving a negative feedback associated with the beam switching indication from the network.

The feedback could be a (positive (ACK) or negative (NACK)) acknowledgement associated with the beam switching indication. Additionally and/or alternatively, the feedback may not be a negative acknowledgement. The feedback could be a PDCCH signaling or a PDSCH signaling. Additionally and/or alternatively, the feedback could be an Uplink Control Information (UCI). The UE could consider the beam switching indication to be successfully received by the network when or if the UE receives the (positive) feedback. The UE may not consider the beam switching indication to be successfully received by the network when or if the UE receives the negative feedback. The UE could consider the beam switching indication to be successfully received by the network when or if the UE does not receive the (positive) feedback or does not receive a negative feedback. The UE may not consider the beam switching indication to be successfully received by the network or could consider the beam switching indication transmission to be failed or not successful when or if the UE does not receive the (positive) feedback or does not receive a negative feedback. Additionally and/or alternatively, the UE could perform beam switching in response to receiving a (positive) feedback. Additionally and/or alternatively, the UE may not perform beam switching (to the selected beam in the beam switching indication) in response to not receiving a (positive) feedback or in response to receiving a negative feedback. Additionally and/or alternatively, the UE may not consider a UE-initiated beam switching procedure of a Cell or of a channel to be not successful if or when receiving a negative feedback of a beam switching indication not associated with the Cell or not associated with the channel.

The positive feedback could indicate successful reception or decoding of the beam switching indication. Additionally and/or alternatively, the positive feedback could indicate the network agreeing/acknowledging the UE to switch the (activated) beam (to the selected beam in the beam switching indication) in response to the beam switching procedure. The negative feedback could indicate unsuccessful reception or decoding of the beam switching indication. Additionally and/or alternatively, the negative feedback could indicate the network not agreeing/acknowledging the UE to switch the (activated) beam (to the selected beam in the beam switching indication) in response to the beam switching procedure.

The positive feedback could be a positive acknowledgement or downlink feedback information (indicating positive acknowledgement) associated with the beam switching indication. The (positive) feedback could be transmitted via a beam indicated in the beam switching indication. The negative feedback could be a negative acknowledgement or a downlink feedback information. The negative feedback could indicate a second beam different from the beam indicated in the beam switching indication. The feedback could be a Medium Access Control (MAC) Control Element (CE) (e.g., beam activation/deactivation MAC CE). The (positive) feedback could indicate (one of) the beam(s) indicated in the beam switching indication. The feedback could be a Downlink Control Information (DCI) indicating beam(s) to be used (e.g., one or more of the beam(s) indicated in the beam switching indication). The (positive) feedback could be a UL grant or DL assignment. The (positive) feedback could be a UL grant or DL assignment associated with or scheduling of a Hybrid Automatic Repeat Request (HARQ) process used to transmit the beam switching indication. The (positive) feedback could be a DL assignment or UL grant associated with or indicating (or transmitted/scheduled via) the beam(s) indicated in the beam switching indication. Alternatively, the feedback could be transmitted/scheduled via a previous beam (activated and not deactivated before the UE transmits the beam switching indication).

Additionally and/or alternatively, the UE could perform beam switching in response to transmitting the beam switching indication. For example, the UE could perform beam switching after transmitting the beam switching indication.

### Timer-Based

Additionally and/or alternatively, the UE could determine whether a beam switching indication is successfully received by a network based on a first timer. The UE could determine whether a beam switching procedure is successfully completed based on a first timer. The UE could start or restart the first timer in response to (re) transmitting the beam switching indication. The UE could start or restart the first timer in response to receiving a UL grant indicating a retransmission of the beam switching indication. The UE could consider the beam switching indication is not successfully received by the network (or not successfully transmitted to the network) if or when the first timer expires, and the UE does not receive a (positive or negative) feedback associated with the beam switching indication from the network. Additionally and/or alternatively, the UE could consider the UE-initiated beam switching (procedure) of the Cell to be failed or not successful in response to expiry/expiration of the first timer. Alternatively, the UE could consider the beam switching indication successfully received by the network (or consider the beam switching procedure successfully completed) if or when the first timer expires. The UE could stop the first timer in response to receiving a (positive or negative) feedback of the beam switching indication or in response to successful completion of the associated beam switching procedure. The UE could cancel a triggered UE-initiated beam switching associated with the beam switching indication in response to expiry of the first timer. The UE could cancel a triggered Scheduling Request (SR) associated with the beam switching indication in response to expiry of the first timer. The UE could stop or cancel a random access procedure associated with the UE-initiated beam switching procedure in response to expiry of the first timer.

Additionally and/or alternatively, the UE could determine whether a beam switching indication is successfully received by a network based on a fourth timer. The UE could determine whether a beam switching procedure is successfully completed based on a fourth timer. The UE could start or restart the first timer in response to triggering or initiating a UE-initiated beam switching (procedure). The UE could consider the beam switching indication is not successfully received by the network (or not successfully transmitted to the network) if or when the fourth timer expires, and the UE does not receive a (positive or negative) feedback associated with the beam switching indication from the network. Alternatively, the UE could consider the beam switching indication successfully received by the network (or consider the beam switching procedure successfully completed) if or when the fourth timer expires. The UE could stop the fourth timer in response to receiving a (positive or negative) feedback of the beam switching indication or in response to successful completion of the associated beam switching procedure. The UE could cancel a triggered UE-initiated beam switching associated with the beam switching indication in response to expiry of the fourth timer. The UE could cancel a triggered SR associated with the beam switching indication in response to expiry of the fourth timer. The UE could stop or cancel a random access procedure associated with the UE-initiated beam switching procedure in response to expiry of the fourth timer.

### Apply the Selected Beam Based on a Timer or a Fixed Time Period

Additionally and/or alternatively, the UE could determine when to apply a selected beam (associated with a Cell) indicated in the beam switching indication based on the first timer (associated with the Cell). The UE could consider the beam switching indication is successfully received by the network if or when the first timer expires, and the UE does not receive a negative feedback associated with the beam switching indication from the network. The UE could apply the selected beam in response to expiry of the first timer. Additionally and/or alternatively, the UE could apply the selected beam after a fixed or configured amount of time (after transmitting the beam switching indication).

Additionally and/or alternatively, the UE could apply the selected beam to the DL or UL channel in response to transmitting the beam switching indication, or in response to receiving the feedback, or in response to the beam switching procedure successfully completing, or in response to the triggered beam switching (corresponding to the DL or UL channel) being canceled.

### If Beam Switching Indication is not Transmitted Due to No Resources Available

Additionally and/or alternatively, the UE could determine whether a UE-initiated beam switching procedure is successful based on a third timer. The UE could start or restart the third timer in response to triggering or initiating the UE-initiated beam switching (procedure). The UE could stop the third timer when or if a beam switching indication for the triggered UE-initiated beam switching (procedure) is (successfully) transmitted. The UE could stop the third timer when or if a UL grant is received (and the UL grant can accommodate or is available for transmitting the beam switching indication). The UE could consider the UE-initiated beam switching procedure to be failed or not successful in response to expiry of the third timer. The UE could cancel a triggered UE-initiated beam switching associated with the beam switching indication in response to expiry of the third timer. The UE could cancel a triggered SR associated with the beam switching indication in response to expiry of the third timer. The UE could stop or cancel a random access procedure associated with the UE-initiated beam switching procedure in response to expiry of the third timer.

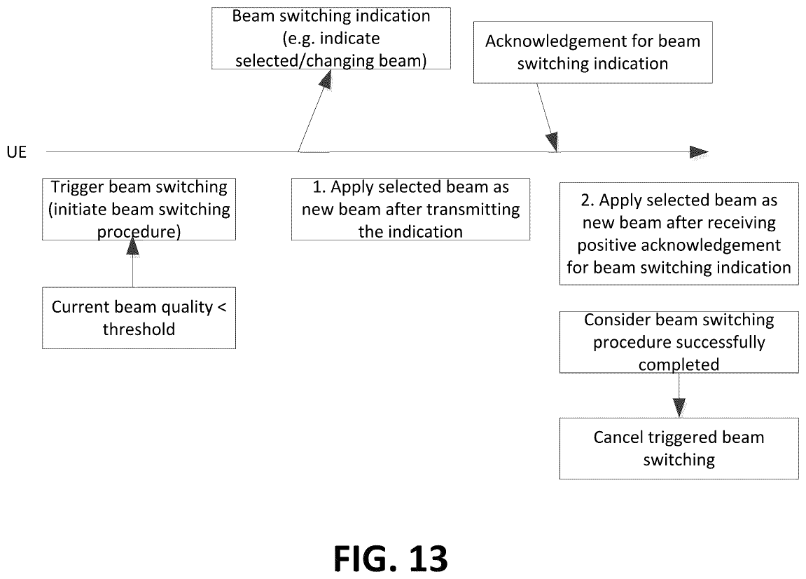

An example is shown in FIG. 13. The UE could be configured and/or activated with a current beam for a DL or UL channel. The UE could perform beam measurement and determine that beam quality of the current beam is smaller than a threshold. The UE could trigger a beam switching (and initiate a beam switching procedure). As long as a beam switching (for a DL or UL channel) is triggered (and not canceled), the UE could generate and transmit a beam switching indication to the network. The UE could select a new beam to apply to the DL or UL channel (e.g., based on a measurement result). The beam switching indication could indicate the selected beam and/or the beam to change for the DL or UL channel. The UE could receive an acknowledgement from the network associated with the beam switching indication. The UE could cancel the triggered beam switching and/or consider the beam switching procedure successfully completed if or when a positive acknowledgement is received for the beam switching indication. The UE could apply the selected beam to the DL or UL channel in response to transmitting the beam switching indication, or in response to receiving the acknowledgement, or in response to the beam switching procedure successfully completing, or in response to the triggered beam switching (corresponding to the DL or UL channel) being canceled. The UE could monitor the acknowledgement or feedback from the network via the selected beam (if or when the UE switches to or applies the selected beam before the beam switching is successfully completed). Alternatively, the UE could monitor the acknowledgement or feedback from the network via the current beam. The UE could apply the selected beam after (a period of time) receiving the acknowledgement or feedback from the network.

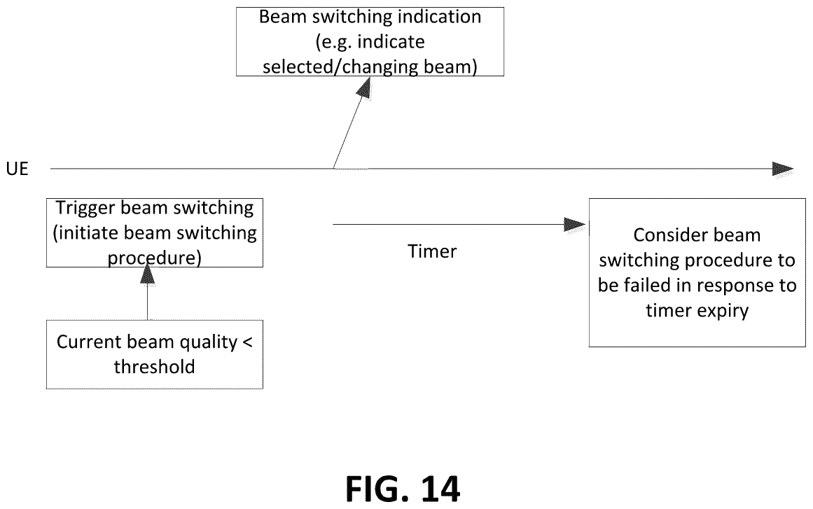

Another example is shown in FIG. 14. The UE could start a timer in response to transmitting the beam switching indication. The UE could consider the beam switching procedure to be failed in response to the timer expiry (and no positive acknowledgement for the beam switching indication is received when the timer is running).

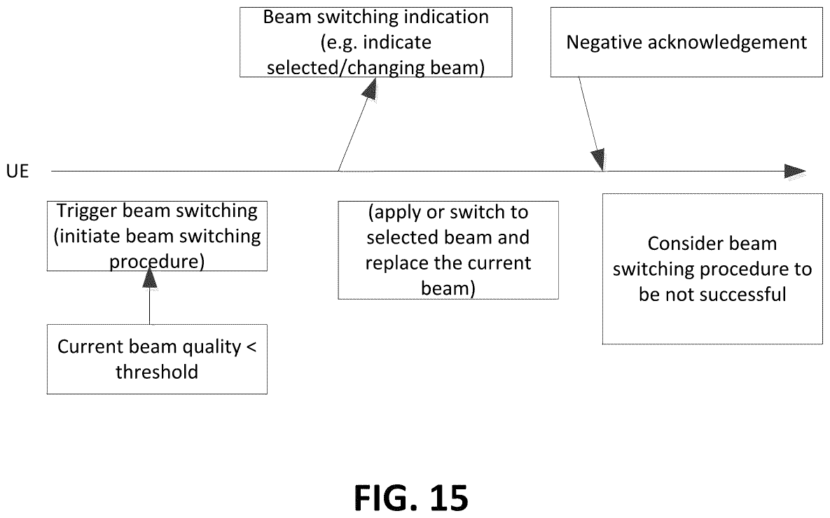

Another example is shown in FIG. 15. The UE could consider the beam switching procedure to be not successful in response to receiving a negative acknowledgement associated with the beam switching indication.

### Network (NW)-UE Indication Conflict

Additionally and/or alternatively, the UE could consider the UE-initiated beam switching procedure (of a channel) of a Cell to be not successful if or when the UE receives a beam change indication (of the channel) associated with the Cell from the network (before the UE-initiated beam switching procedure is successfully completed). The UE could receive the beam change indication before transmitting the beam switching indication (and after triggering or initiating the UE-initiated beam switching (procedure)). The UE could receive the beam change indication after transmitting the beam switching indication (and before the UE-initiated beam switching procedure is successfully completed). The UE could consider the UE-initiated beam switching procedure to be not successful if or when the UE receives a beam change indication from the network before receiving a (positive) feedback associated with a beam switching indication. The UE could cancel triggered UE-initiated beam switching (associated with a cell and/or a channel) if or when receiving the beam change indication (associated with the cell and/or the channel). The UE could cancel a triggered SR associated with the beam switching indication in response to receiving the beam change indication. The UE could stop or cancel a random access procedure associated with the UE-initiated beam switching procedure in response to receiving the beam change indication.

The UE may not cancel a triggered UE-initiated beam switching associated with a cell and/or a channel if or when receiving the beam change indication not associated with the cell and/or the channel. The UE may not cancel a triggered SR associated with the beam switching indication associated with a cell and/or a channel in response to receiving the beam change indication not associated with the cell and/or the channel. The UE may not stop or cancel a random access procedure associated with the UE-initiated beam switching procedure associated with a cell and/or a channel in response to receiving the beam change indication not associated with the cell and/or the channel.

The beam change indication from the network could be a MAC CE (e.g., TCI state activation/deactivation MAC CE or LTM Cell switch MAC CE). The beam change indication from the network could indicate a cell switch trigger information (to a candidate cell of a candidate configuration). The beam change indication from the network could be a Radio Resource Control (RRC) message (e.g., PDSCH-config, ControlResourceSet (CORESET), Bandwidth Part (BWP)-UplinkDedicated). The RRC message could contain TCI state addition information (e.g., a list of TCI states to be added) or TCI state release information (e.g., indicates a list of TCI states to be released). The beam change indication from the network could be a DCI. The DCI could indicate a TCI codepoint associated with one or more (activated) beam(s) or TCI state(s) different from current (activated) beam(s) or TCI state(s) for a UL or DL channel. The beam change indication could indicate or contain beam(s) different from beam(s) indicated in the beam switching indication. The beam change indication could indicate or contain Cell(s) different from Cell(s) indicated in the beam switching indication. The beam change indication may not indicate or contain beam(s) indicated in the beam switching indication.

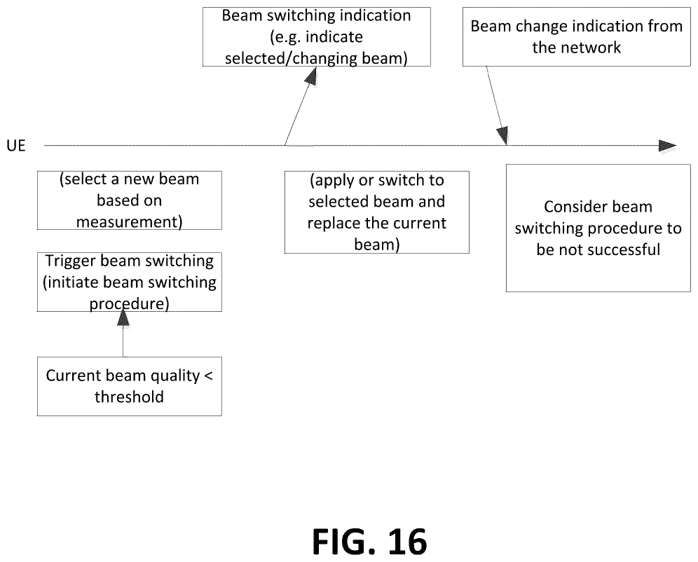

An example is shown in FIG. 16. The UE (with a pending, triggered and not canceled beam switching) could receive a beam change indication from the network. The beam change indication could be received before or after generating the beam switching indication. The beam change indication could be received before or after the UE applies or switches to the selected beam. The UE could consider the beam switching procedure (for a DL or UL channel) as failed or not successful in response to receiving the beam change indication (for at least the DL or UL channel).

Additionally and/or alternatively, the UE could consider a UE-initiated beam switching procedure (of a Channel) (of a Cell) as failed or not successful when or if a maximum number of (re) transmission(s) has been reached for the beam switching indication (of the Channel) (of the Cell) associated with the UE-initiated beam switching procedure. The UE may not receive a positive feedback for the UE-initiated beam switching procedure when the beam switching indication has been transmitted for a maximum number of times.

### Error Handling

When the UE considers a (UE-initiated) beam switching procedure (for a DL channel, or UL channel, or Sounding Reference Signal (SRS) of a Cell) as failed or not successful, the UE could perform one or more (or part) of the action(s) (for the DL/UL channel or SRS of the Cell) below. Additionally and/or alternatively, the UE could perform one or more (or part) of the action(s) (for a DL/UL channel of a Cell) below in response to the beam switching indication (associated with the DL/UL channel of the Cell) being not successfully received by (or not successfully transmitted to) the network.

Additionally and/or alternatively, when the UE considers a (UE-initiated) beam switching procedure (for a DL channel, or UL channel, or SRS) of a Cell as failed or not successful, the UE may not perform one or more of the action(s) below (for another DL/UL channel or SRS) of (the Cell or) another Cell.

### Retransmsisison Based on a Second Timer or Based on Negative ACK (NACK)

One action could be that the UE could perform (re) transmission of the beam switching indication to the network. The UE could determine to perform retransmission of a beam switching indication (of a channel) (of a Cell) based on at least a negative feedback (from the network) of the beam switching indication (of the channel) (of the cell). The UE could be configured with one or more (re) transmission resource(s) for beam switching indication. The one or more (re) transmission resource(s) could be PUSCH resources or PUCCH resources. For example, the UE could (re) transmit the beam switching indication on a (first available) (re) transmission resource (or a UL, PUSCH, or PUCCH resource) after receiving a negative feedback (associated with the beam switching indication) from the network. The UE could (re) transmit the beam switching indication on a (first available) (re) transmission resource (or a UL, PUSCH, or PUCCH resource) after not receiving a positive feedback from the network (after expiry of the first timer or a second timer).

Additionally and/or alternatively, another action could be that the UE could trigger a UE-initiated beam switching.

Additionally and/or alternatively, another action could be that the UE could generate and transmit a second beam switching indication to the network. The UE could determine to perform transmission of the second beam switching indication (for a Cell) based on at least a negative feedback (from the network) of the beam switching indication (for the Cell). The UE could be configured with one or more (re) transmission resource(s) for the second beam switching indication. The one or more (re) transmission resource(s) could be PUSCH resources or PUCCH resources. For example, the UE could (re) transmit the second beam switching indication on a (first available) (re) transmission resource (or a UL, PUSCH, or PUCCH resource) after receiving a negative feedback from the network. The UE could (re) transmit the second beam switching indication on a (first available) (re) transmission resource (or a UL, PUSCH, or PUCCH resource) after not receiving a positive feedback from the network (after expiry of the first timer or a second timer). The second beam switching indication could contain different beam information and/or beam quality information from the beam switching indication. The second beam switching indication could be based on at least beam measurement after transmission of the beam switching indication.

The UE could be configured with an SR configuration for beam switching indication. The UE could trigger an SR for beam switching indication if or when there are no available resources for (re) transmitting the beam switching indication.

Additionally and/or alternatively, the UE could determine whether to perform (re)transmission of the beam switching indication or the second beam switching indication based on a status of a second timer. The second timer could be configured by the network (per DL or UL or per channel). The UE could start or restart the second timer in response to (re) transmission of the beam switching indication or the second beam switching indication. The UE could determine to (re) transmit the beam switching indication or the second beam switching indication in response to expiry of the second timer. The second timer could be a same or different timer from the first timer. The UE could consider the (re) transmission of the beam switching indication not successful in response to expiry of the second timer. The UE could consider the UE-initiated beam switching procedure as failed or not successful when the second timer expires, and the UE has transmitted the beam switching indication for a maximum number of times. The UE could stop the second timer when receiving a (positive) feedback associated with the beam switching indication.

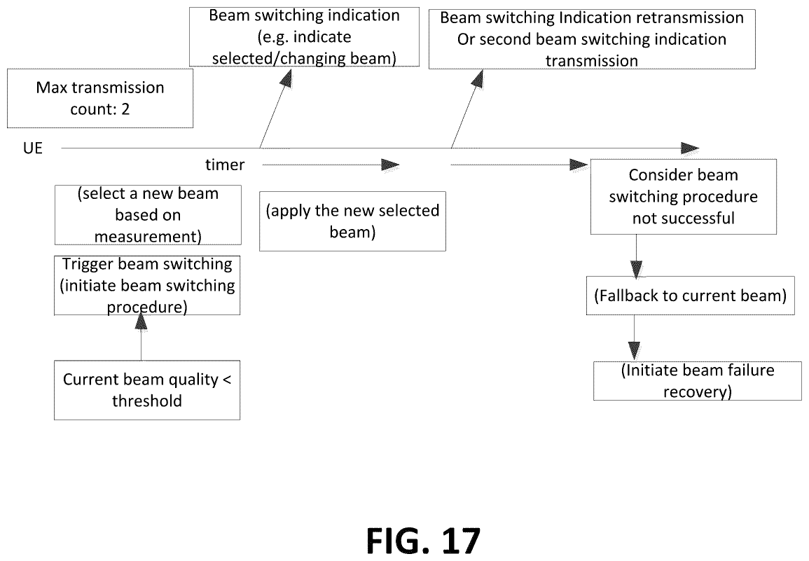

An example is shown in FIG. 17. The UE is configured with a maximum transmission number for the beam switching indication. The UE could trigger a beam switching and/or initiate a beam switching procedure in response to a current beam with beam quality lower than a threshold. The UE could generate and transmit a beam switching indication to the network. The UE could start a timer (e.g., a second timer) in response to transmitting the beam switching indication. The UE could apply to the new selected beam in response to initiating the procedure or transmitting the indication. In response to expiry of the timer (and the UE does not receive a feedback associated with the indication), the UE could retransmit the beam switching indication (or transmit a second beam switching indication) at a first available (re) transmission resource for the beam switching indication to the network. The resource could be scheduled or configured by the network. The resource could be a PUSCH or a PUCCH resource. The UE could trigger an SR to request resource(s) from the network if or when no resource is avaible for transmission. The UE could start the timer (e.g., the second timer) in response to (re) transmission of the indication. In response to expiry of the timer and the maximum number for (re) transmission reached (and no feedback for the indication is received), the UE could consider the beam switching procedure failed or not successful. The UE could fall back to the current beam (if a new selected beam was applied), and/or the UE could perform a beam failure recovery procedure in response to failure of (UE-initiated) beam switching.

### Apply Beam in Beam Change Indication

Additionally and/or alternatively, one action could be that the UE could apply or activate a beam indicated in the beam change indication (for a Cell indicated by the network) in response to receiving the beam change indication. The UE could cancel a (or all) triggered UE-initiated beam switching trigger (for a DL channel or UL channel or SRS of a Cell) in response to receiving the beam change indication (associated with the DL channel or UL channel or SRS of the Cell) from the network. The beam change indication may not be a feedback associated with a beam switching indication (initiated by the UE) transmitted to the network. The Cell could be indicated in the beam change indication. The Cell could be a (activated) Serving Cell of the UE (before a UE-initiated beam switching procedure is triggered). The Cell could be associated with a candidate configuration (before a UE-initiated beam switching procedure is triggered). Alternatively, the cell may not be associated with a candidate configuration.

Additionally and/or alternatively, one action could be that the UE could ignore or drop the beam change indication (associated with a Cell or associated with a DL/UL channel of a Cell) from the network during a UE-initiated beam switching procedure (of the Cell or of the DL/UL channel of the Cell) (and after a beam switching indication associated with the UE-initiated beam switching procedure is transmitted). The UE may not apply or activate beam(s) indicated in the beam change indication (associated with a Cell or associated with a DL/UL channel of a Cell) from the network (when received the beam change indication) during the UE-initiated beam switching procedure (associated with the Cell or associated with the DL/UL channel of a Cell) (and after selecting a beam and/or generating a beam switching indication).

### Fall Back to Previous Beam

Additionally and/or alternatively, one action could be that the UE could fall back to a previous beam. The UE could fall back to a previous beam in response to expiry of the first timer (without receiving a positive feedback from the network when the first timer is running). The UE could fall back to a previous beam in response to receiving a negative feedback associated with the beam switching indication from the network. The UE performs communication (on a DL or UL channel) via the previous beam before initiating or triggering the beam switching (procedure) (associated with the DL or UL channel). The previous beam could be a (current) beam activated and not deactivated before the UE transmits the beam switching indication.

When falling back to a previous beam (on a DL or UL channel of a Cell), the UE could deactivate a current (selected) beam (on the DL or UL channel of the Cell) (activated by the UE or applied by the UE in response to a beam switching procedure or in response to a triggered beam switching) and activate the previous beam (on the DL or UL channel of the Cell). The UE could deactivate a current (selected) beam associated with a (new) Serving Cell and activate a (previous) beam associated with a (previous) Serving Cell. The previous Serving Cell could be a (activated) Serving Cell before triggering or completing the (UE-initiated) beam switching procedure.

### Trigger Beam Failure Recovery (BFR)

Additionally and/or alternatively, one action could be that the UE could trigger a BFR (or initiate a beam failure recovery procedure) (associated with the Cell). The UE could trigger a BFR in response to expiry of the first timer (without receiving a positive feedback from the network when the first timer is running). The UE could trigger a BFR of (a BFD-Reference Signal (RS) set of) a Cell in response to the UE considering a (UE-initiated) beam switching procedure for (the BFD-RS set of) the Cell as failed or not successful. In response to the triggered and not canceled BFR, the UE could generate and transmit a BFR MAC CE to the network indicating the selected beam (or other beam(s)) to the network. The Cell could be a Serving Cell (associated with the (UE-initiated) beam switching procedure) of the UE. The Cell could be a (previous) Serving Cell (not associated with the (UE-initiated) beam switching procedure) of the UE before triggering or completing the (UE-initiated) beam switching procedure.

### Trigger Upper Layer Message or Beam Report

Additionally and/or alternatively, one action could be that the UE could generate or trigger to generate an upper layer message to the network. The UE could generate the upper layer message in response to the (UE-initiated) beam failure switching not being completed successfully. The upper layer message could be a BFR MAC CE. Additionally or alternatively, one action could be that the UE could trigger or generate a beam report. The beam report could be an L1-RSRP or L1-SINR report of a Cell. The upper layer message could be a Radio Link Failure (RLF) message or indicates an RLF of the Cell.

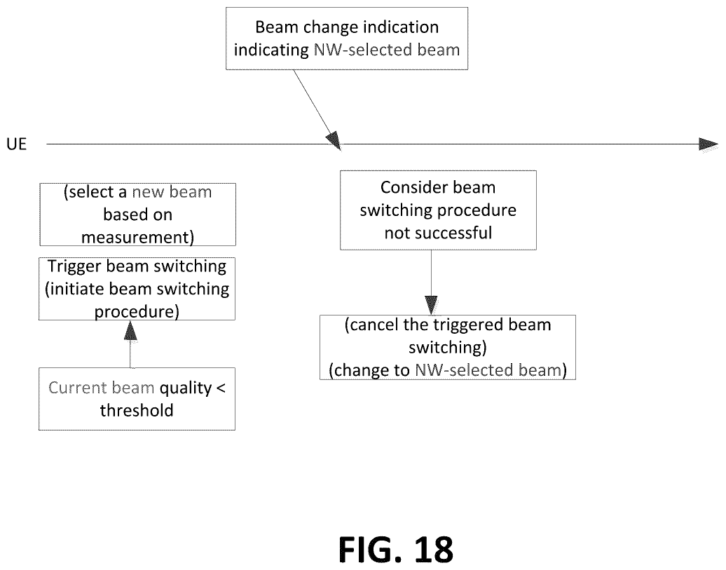

Additionally and/or alternatively, another example is shown in FIG. 18. A UE could trigger a (UE-initated) beam switching associated with a Cell in response to an event (e.g., the current beam quality is lower than a threshold). The UE could select a new beam based on (L1) measurement of the Cell. The UE could, before generating and/or transmitting a beam switching indication (indicating the new beam) to the network, receiving a beam change indication associated with at least the Cell (e.g., a beam/TCI state activation/deactivation MAC CE). The UE, in response to the beam change indication, could cancel the triggered (UE-initiated) beam switching and/or cancel a triggered SR and/or stop a random access procedure initiated for the UE-initiated beam switching. The beam change indication could indicate a second beam different from the (UE-selected) new beam.

For the embodiments, examples, and concepts detailed above and herein, the following aspects and embodiments are possible.

A beam mentioned herein could be associated with or be replaced with (DL or UL) TCI state(s). Additionally and/or alternatively, the beam mentioned herein could be associated or be replaced with SRS resource set(s). Additionally and/or alternatively, the beam mentioned herein could be associated or be replaced with spatio relation info. Additionally and/or alternatively, the beam mentioned herein could be associated or be replaced with SSB or CSI-RS.

The beam switching indication could be or contain a beam report. Additionally and/or alternatively, the beam switching indication could be a signaling/message different from a beam report. The beam switching indication could be generated/initiated/triggered by the UE. The beam switching indication could contain or indicate a beam e.g., with a beam quality higher than or equal to a threshold. Additionally and/or alternatively, the beam switching indication could contain or indicate more than one beam, e.g., with a beam quality higher than or equal to a threshold. Additionally and/or alternatively, the beam switching indication could contain or indicate the beam(s) the UE intends to or is going to or desires to switch to or apply/activate. The beam switching indication could contain or indicate quality of the indicated beam(s). The beam switching indication could be a notification. The beam switching indication could be a MAC CE. The beam switching indication could be a PUCCH signaling (e.g., UCI). The beam switching indication could indicate a Cell (e.g., a cell index).

The beam change indication could be from a network. The beam change indication may not be generated by the UE. The beam change indication could be a TCI state activation/deactivation MAC CE. The beam change indication could be an RRC message. The beam change indication could be a DCI.

The beam switching procedure could be a UE-initiated beam switching procedure. When considering the beam switching procedure to be failed, the UE could consider the beam switching procedure as not successful or not successfully completed. The beam switching procedure and/or the trigger of the beam switching could be per channel (e.g., PDCCH, PUCCH, PDSCH, PUSCH and/or SRS) or per UE. The beam switching procedure and/or the trigger of the beam switching could be for UL or for DL, or for both DL and UL. The UE could trigger the beam switching (associated with DL or UL or the channel) when or if a quality of a (activated) beam (associated with DL or UL or the channel) is lower than a threshold.

The beam switching indication and beam change indication could be associated with PDCCH, PUCCH, PDSCH, PUSCH, and/or SRS (of a Cell).

The UE could determine to (generate and) transmit a beam switching indication based on a beam measurement result.

The beam switching indication could be associated with a DL or UL channel or SRS of a Cell. The trigger of beam switching could be associated with a DL or UL channel or SRS of a Cell. The UE may not generate a beam switching indication for the DL or UL channel of a Cell when there is no triggered beam switching for the DL or UL channel of the Cell.

The beam quality could be (L1-)RSRP or (L1-)Reference Signal Received Quality (RSRQ) or (L1-)SINR.

The beam measurement could be an L1 beam measurement. The beam measurement could be an L1-RSRP or an L1-SINR. The beam switching indication could be transmitted by the UE (and received by the network).

Additionally and/or alternatively, the UE could determine to (generate and) transmit the beam switching indication based on a trigger or a procedure being triggered. The trigger could be associated with a UE-initiating beam reporting. Additionally and/or alternatively, the UE could determine to (generate and) transmit the beam switching indication based on an L1 beam measurement result (or beam quality) associated with a current beam of a Cell being lower than or equal to a threshold (and beam measurement result or beam quality of a candidate beam or a selected beam being higher than or equal to a threshold).

The selected beam could be a beam indicated in the beam switching indication. The selected beam could be a candidate beam (configured for (a DL or UL channel of) the UE) with a beam quality higher than or equal to a threshold. The selected beam could be a beam selected by the UE in a (UE-initiated) beam switching procedure. The selected beam could be a beam associated with a Serving Cell of the UE or a candidate cell (e.g., candidate PCell) associated with a candidate configuration for LTM of the UE.

The (positive) feedback could be transmitted or received via the selected beam.

The UE-initiated beam switching procedure could be triggered or initiated per Cell or per DL/UL channel of the Cell. The beam switching indication could be associated with a (Serving) Cell and/or associated with a DL/UL channel of the (Serving) Cell.

The UE-initiated beam switching procedure, the triggered UE-initiated beam switching, the triggered BFR, the triggered SR, the beam switching indication, the beam change indication, the first timer, the second timer, the third timer, and/or the fourth timer could be associated with a same channel and/or a same Cell.

The DL or UL channel could be PDCCH, PDSCH, PUCCH, and/or PUSCH.

The first, second, third, and fourth timer could be configured or maintained per Cell or per channel or per UE.

Note that any of above and herein methods, alternatives, examples, and embodiments may be combined, in whole or in part, or applied simultaneously or separately.

Exemplary embodiments of the present invention are described below.

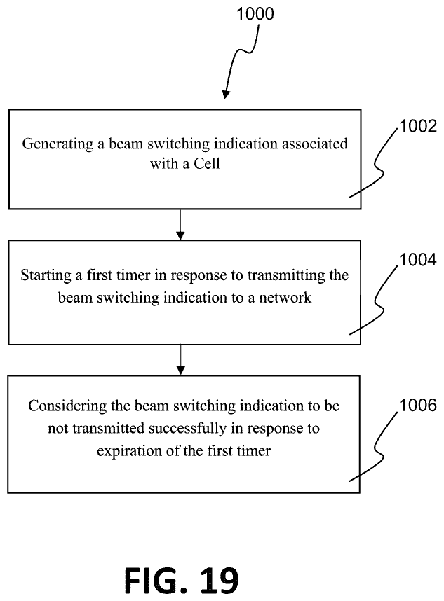

Referring to FIG. 19, with this and other concepts, systems, and methods of the present invention, a method 1000 for a UE comprises generating a beam switching indication associated with a Cell (step 1002), starting a first timer in response to transmitting the beam switching indication to a network (step 1004), and considering the beam switching indication to be not transmitted successfully in response to expiration of the first timer (step 1006).

In various embodiments, the beam switching indication is associated with a serving cell of the UE.

In various embodiments, the beam switching indication is associated with a DL or UL channel of the UE.

In various embodiments, the DL or UL channel could be PDCCH, PDSCH, PUCCH, and/or PUSCH.

In various embodiments, the beam switching indication indicates a candidate beam or a selected beam of the UE.

In various embodiments, the selected beam is a beam with beam quality higher than or equal to a threshold.

In various embodiments, the beam quality is L1-RSRP or L1-SINR.

In various embodiments, the UE considers a beam switching procedure to be failed or not successful in response to expiry of the first timer.

In various embodiments, the UE retransmits the beam switching indication in response to expiry of the first timer.

In various embodiments, the UE starts the first timer in response to retransmission of the beam switching indication.

In various embodiments, the UE generates the beam switching indication in response to a triggered and not canceled beam switching.

In various embodiments, the UE switches to or applies the selected beam indicated in the beam switching indication in response to transmitting the beam switching indication.

In various embodiments, the UE switches to or applies a previous beam in response to expiry of the first timer, wherein the UE performs communication via the previous beam on the Cell before the UE switches to the selected beam.

In various embodiments, the method further comprises considering the beam switching indication to be successfully received by the network in response to reception of a positive feedback associated with the beam switching indication.

In various embodiments, the feedback could be a downlink feedback information.

In various embodiments, the feedback could be a DCI or a MAC CE.

Referring back to FIGS. 3 and 4, in one or more embodiments from the perspective of a UE, the device 300 includes a program code 312 stored in memory 310 of the transmitter. The CPU 308 could execute program code 312 to: (i) generate a beam switching indication associated with a Cell; (ii) start a first timer in response to transmitting the beam switching indication to a network; and (iii) consider the beam switching indication to be not transmitted successfully in response to expiration of the first timerd. Moreover, the CPU 308 can execute the program code 312 to perform all of the described actions, steps, and methods described above, below, or otherwise herein.

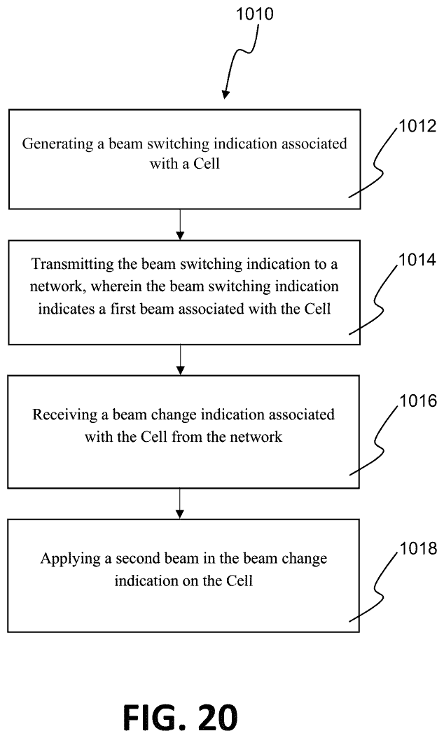

Referring to FIG. 20, with this and other concepts, systems, and methods of the present invention, a method 1010 for a UE comprises generating a beam switching indication associated with a Cell (step 1012), transmitting the beam switching indication to a network, wherein the beam switching indication indicates a first beam associated with the Cell (step 1014), receiving a beam change indication associated with the Cell from the network (step 1016), and applying a second beam in the beam change indication on the Cell (step 1018).

In various embodiments, the beam switching indication is associated with a serving cell of the UE.

In various embodiments, the beam switching indication is associated with a DL or UL channel of the UE.

In various embodiments, the DL or UL channel could be PDCCH, PDSCH, PUCCH, and/or PUSCH.

In various embodiments, the beam switching indication indicates a candidate beam or a selected beam of the UE.

In various embodiments, the selected beam is a beam with beam quality higher than or equal to a threshold.

In various embodiments, the beam quality is L1-RSRP or L1-SINR.

In various embodiments, the UE applies the first beam on the Cell in response to transmitting the beam switching indication.

In various embodiments, the UE receives the beam change indication before receiving a feedback from the network associated with the beam switching indication.

In various embodiments, the triggered beam switching and beam switching indication is associated with a UE-initiated beam switching procedure.

In various embodiments, the UE considers the beam switching procedure to be successfully completed in response to a positive feedback associated with the beam switching indication.

In various embodiments, the UE cancels the triggered beam switching in response to a positive feedback associated with the beam switching indication.

In various embodiments, the beam change indication is a MAC CE activating and/or deactivating a beam associated with a channel of the cell.

In various embodiments, the beam is a SSB or CSI-RS.

In various embodiments, the beam is associated with a UL or DL TCI state.

In various embodiments, the beam switching indication is associated with or indicates a DL or UL channel of the Cell.

In various embodiments, the beam switching indication is a PUCCH signaling or a PUSCH signaling.

Referring back to FIGS. 3 and 4, in one or more embodiments from the perspective of a UE, the device 300 includes a program code 312 stored in memory 310 of the transmitter. The CPU 308 could execute program code 312 to: (i) generate a beam switching indication associated with a Cell; (ii) transmit the beam switching indication to a network, wherein the beam switching indication indicates a first beam associated with the Cell; (iii) receive a beam change indication associated with the Cell from the network; and (iv) apply a second beam in the beam change indication on the Cell. Moreover, the CPU 308 can execute the program code 312 to perform all of the described actions, steps, and methods described above, below, or otherwise herein.

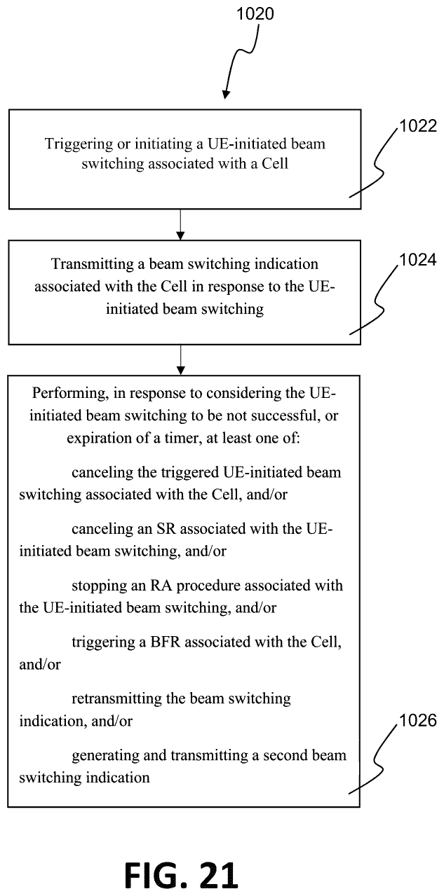

Referring to FIG. 21, with this and other concepts, systems, and methods of the present invention, a method 1020 for a UE comprises triggering or initiating a UE-initiated beam switching associated with a Cell (step 1022), transmitting a beam switching indication associated with the Cell in response to the UE-initiated beam switching (step 1024), and performing, in response to considering the UE-initiated beam switching to be not successful, or expiration of a timer, at least one of: canceling the triggered UE-initiated beam switching associated with the Cell, and/or canceling an SR associated with the UE-initiated beam switching, and/or stopping an RA procedure associated with the UE-initiated beam switching, and/or triggering a BFR associated with the Cell, and/or retransmitting the beam switching indication, and/or generating and transmitting a second beam switching indication (step 1026).

In various embodiments, the UE starts or restarts the timer in response to the transmission of the beam switching indication, the retransmission of the beam switching indication, or the triggering or initiating of the UE-initiated beam switching.

In various embodiments, the UE stops the timer in response to receiving a feedback, from a network, associated with the beam switching indication.

In various embodiments, the feedback is a negative feedback indicating the network not agreeing or acknowledging that the UE is to switch to a selected beam indicated in the beam switching indication.

In various embodiments, the beam switching indication is associated with a beam for PDCCH, PDSCH, PUCCH, and/or PUSCH of the UE, and/or the beam switching indication indicates a candidate beam or a selected beam of the UE, and/or the beam switching indication is a MAC CE or a PUCCH signaling (e.g., UCI), and/or the beam switching indication is associated with an LTM candidate cell.

In various embodiments, in response to considering the UE-initiated beam switching to be successful, the UE performs at least one of: beam switching to the candidate beam or the selected beam, and/or an LTM cell switch to the LTM candidate cell.

In various embodiments, the UE triggers the BFR associated with the Cell in response to a (re) transmission number of the beam switching indication reaching a maximum number.

Referring back to FIGS. 3 and 4, in one or more embodiments from the perspective of a UE, the device 300 includes a program code 312 stored in memory 310 of the transmitter. The CPU 308 could execute program code 312 to: (i) trigger or initiate a UE-initiated beam switching associated with a Cell; (ii) transmit a beam switching indication associated with the Cell in response to the UE-initiated beam switching; and (iii) perform, in response to considering the UE-initiated beam switching to be not successful, or expiration of a timer, at least one of: canceling the triggered UE-initiated beam switching associated with the Cell, and/or canceling an SR associated with the UE-initiated beam switching, and/or stopping an RA procedure associated with the UE-initiated beam switching, and/or triggering a BFR associated with the Cell, and/or retransmitting the beam switching indication, and/or generating and transmitting a second beam switching indication. Moreover, the CPU 308 can execute the program code 312 to perform all of the described actions, steps, and methods described above, below, or otherwise herein.

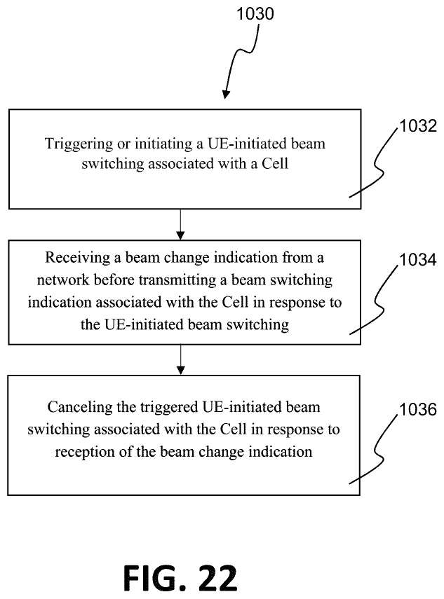

Referring to FIG. 22, with this and other concepts, systems, and methods of the present invention, a method 1030 for a UE comprises triggering or initiating a UE-initiated beam switching associated with a Cell (step 1032), receiving a beam change indication from a network before transmitting a beam switching indication associated with the Cell in response to the UE-initiated beam switching (step 1034), and canceling the triggered UE-initiated beam switching associated with the Cell in response to reception of the beam change indication (step 1036).

In various embodiments, the beam change indication is a MAC CE activating and/or deactivating a beam associated with a channel of the Cell.

In various embodiments, the beam switching indication is associated with a beam for PDCCH, PDSCH, PUCCH, and/or PUSCH of the UE, and/or the beam switching indication indicates a candidate beam or a selected beam of the UE, and/or the beam switching indication is a MAC CE or a PUCCH signaling (e.g., UCI), and/or the beam switching indication is associated with an LTM candidate cell.

In various embodiments, the UE cancels an SR associated with the UE-initiated beam switching in response to the reception of the beam change indication, and/or the UE stops an RA procedure associated with the UE-initiated beam switching in response to the reception of the beam change indication.

In various embodiments, the UE applies a beam indicated in the beam change indication in response to receiving the beam change indication.

Referring back to FIGS. 3 and 4, in one or more embodiments from the perspective of a UE, the device 300 includes a program code 312 stored in memory 310 of the transmitter. The CPU 308 could execute program code 312 to: (i) trigger or initiate a UE-initiated beam switching associated with a Cell; (ii) receive a beam change indication from a network before transmitting a beam switching indication associated with the Cell in response to the UE-initiated beam switching; and (iii) cancel the triggered UE-initiated beam switching associated with the Cell in response to reception of the beam change indication. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a User Equipment (UE), comprising:
triggering or initiating a UE-initiated beam switching associated with a Cell;
transmitting a beam switching indication associated with the Cell in response to the UE-initiated beam switching; and
performing, in response to considering the UE-initiated beam switching to be not successful, or expiration of a timer, at least one of:
canceling the triggered UE-initiated beam switching associated with the Cell;
canceling a Scheduling Request (SR) associated with the UE-initiated beam switching;
stopping a Random Access (RA) procedure associated with the UE-initiated beam switching;
triggering a Beam Failure Recovery (BFR) associated with the Cell;
retransmitting the beam switching indication; and/or
generating and transmitting a second beam switching indication.

2. The method of claim 1, wherein the UE starts or restarts the timer in response to the transmission of the beam switching indication, the retransmission of the beam switching indication, or the triggering or initiating of the UE-initiated beam switching.

3. The method of claim 1, wherein the UE stops the timer in response to receiving a feedback, from a network, associated with the beam switching indication.

4. The method of claim 3, wherein the feedback is a negative feedback indicating the network not agreeing or acknowledging that the UE is to switch to a selected beam indicated in the beam switching indication.

5. The method of claim 1, wherein:
the beam switching indication is associated with a beam for Physical Downlink Control Channel (PDCCH), Physical Downlink Shared Channel (PDSCH), Physical Uplink Control Channel (PUCCH), and/or Physical Uplink Shared Channel (PUSCH) of the UE, and/or
the beam switching indication indicates a candidate beam or a selected beam of the UE, and/or
the beam switching indication is a Medium Access Control (MAC) Control Element (CE) or a PUCCH signaling, and/or
the beam switching indication is associated with an L1/L2-Triggered Mobility (LTM) candidate cell.

6. The method of claim 5, wherein in response to considering the UE-initiated beam switching to be successful, the UE performs at least one of: beam switching to the candidate beam or the selected beam, and/or an LTM cell switch to the LTM candidate cell.

7. The method of claim 1, wherein the UE triggers the BFR associated with the Cell in response to a transmission or retransmission number of the beam switching indication reaching a maximum number.

8. A method of a User Equipment (UE), comprising:
triggering or initiating a UE-initiated beam switching associated with a Cell;
receiving a beam change indication from a network before transmitting a beam switching indication associated with the Cell in response to the UE-initiated beam switching; and
canceling the triggered UE-initiated beam switching associated with the Cell in response to reception of the beam change indication.

9. The method of claim 8, wherein the beam change indication is a Medium Access Control (MAC) Control Element (CE) activating and/or deactivating a beam associated with a channel of the Cell.

10. The method of claim 8, wherein:
the beam switching indication is associated with a beam for Physical Downlink Control Channel (PDCCH), Physical Downlink Shared Channel (PDSCH), Physical Uplink Control Channel (PUCCH), and/or Physical Uplink Shared Channel (PUSCH) of the UE, and/or
the beam switching indication indicates a candidate beam or a selected beam of the UE, and/or
the beam switching indication is a MAC CE or a PUCCH signaling, and/or
the beam switching indication is associated with an L1/L2-Triggered Mobility (LTM) candidate cell.

11. The method of claim 8, wherein:
the UE cancels a Scheduling Request (SR) associated with the UE-initiated beam switching in response to the reception of the beam change indication, and/or
the UE stops a Random Access (RA) procedure associated with the UE-initiated beam switching in response to the reception of the beam change indication.

12. The method of claim 8, wherein the UE applies a beam indicated in the beam change indication in response to receiving the beam change indication.

13. A User Equipment (UE), comprising:
a memory; and
a processor operatively coupled with the memory, wherein the processor is configured to execute a program code to:
trigger or initiate a UE-initiated beam switching associated with a Cell;
transmit a beam switching indication associated with the Cell in response to the UE-initiated beam switching; and
perform, in response to considering the UE-initiated beam switching to be not successful, or expiration of a timer, at least one of:
canceling the triggered UE-initiated beam switching associated with the Cell;
canceling a Scheduling Request (SR) associated with the UE-initiated beam switching;
stopping a Random Access (RA) procedure associated with the UE-initiated beam switching;
triggering a Beam Failure Recovery (BFR) associated with the Cell;
retransmitting the beam switching indication; and/or
generating and transmitting a second beam switching indication.

14. The UE of claim 13, wherein the UE starts or restarts the timer in response to the transmission of the beam switching indication, the retransmission of the beam switching indication, or the triggering or initiating of the UE-initiated beam switching.

15. The UE of claim 13, wherein the UE stops the timer in response to receiving a feedback, from a network, associated with the beam switching indication.

16. The UE of claim 15, wherein the feedback is a negative feedback indicating the network not agreeing or acknowledging that the UE is to switch to a selected beam indicated in the beam switching indication.

17. The UE of claim 13, wherein:
the beam switching indication is associated with a beam for Physical Downlink Control Channel (PDCCH), Physical Downlink Shared Channel (PDSCH), Physical Uplink Control Channel (PUCCH), and/or Physical Uplink Shared Channel (PUSCH) of the UE, and/or
the beam switching indication indicates a candidate beam or a selected beam of the UE, and/or
the beam switching indication is a Medium Access Control (MAC) Control Element (CE) or a PUCCH signaling, and/or
the beam switching indication is associated with a L1/L2-Triggered Mobility (LTM) candidate cell.

18. The UE of claim 17, wherein in response to considering the UE-initiated beam switching to be successful, the UE performs beam switching to the candidate beam or the selected beam.

19. The UE of claim 17, wherein in response to considering the UE-initiated beam switching to be successful, the UE performs an LTM cell switch to the LTM candidate cell.

20. The UE of claim 13, wherein the UE triggers the BFR associated with the Cell in response to a transmission or retransmission number of the beam switching indication reaching a maximum number.
